(19) United States
(12) Patent Application Publication
(10) Pub. No.: US 2024/0255745 A1
(43) Pub. Date: Aug. 1, 2024

(54) Light Sheet Microscopy

(71) Applicant: University of Georgia Research Foundation, Inc., Athens, GA (US)

(72) Inventors: Peter A. Kner, Suwanee, GA (US); Yang Liu, San Jose, CA (US)

(73) Assignee: University of Georgia Research Foundation, Inc., Athens, GA (US)

(21) Appl. No.: 18/428,342

(22) Filed: Jan. 31, 2024

Related U.S. Application Data
(60) Provisional application No. 63/442,303, filed on Jan. 31, 2023.

(51) Int. Cl. G02B 21/06; G02B 21/04; G02B 21/16; G02B 21/36

(52) U.S. Cl. CPC G02B 21/06; G02B 21/04; G02B 21/16; G02B 21/367

(57) ABSTRACT

Provided herein are microscopes providing multi-directional illumination of a sample volume by alternately reflecting a light sheet exiting a single objective lens off of multiple reflectors positioned about the sample volume. The provided microscopes exhibit high lateral and axial resolution and are particularly useful for imaging thick samples. Also provided are methods and computer instructions and systems for using the provided microscopes.

### CROSS-REFERENCES TO RELATED APPLICATIONS

This application claims the priority benefit of and priority to U.S. Provisional Patent Application No. 63/442,303 filed Jan. 31, 2023, the full disclosure of which is incorporated by reference in its entirety for all purposes.

### STATEMENT AS TO RIGHTS TO INVENTIONS MADE UNDER FEDERALLY SPONSORED RESEARCH AND DEVELOPMENT

This invention was made with government support under Grant Nos. NS115496 and GM140366 awarded by the National Institutes of Health. The government has certain rights in the invention.

### BACKGROUND

The ability to observe a process or an object under investigation is a critical step towards fundamental understanding. Imaging technologies have enabled us to gain this ability on macroscopic and microscopic levels, making them very important tools for advancing science and our knowledge of nature. Among all of the imaging techniques available, light microscopy has played perhaps the most substantial role in the study of biological science. Light microscopes use a series of lenses and visible light to enlarge the image of an object. These instruments allow researchers to examine the details that are normally invisible to the human eye.

Light Sheet Microscopy (LSM), in which the sample is illuminated by a thin sheet orthogonal to the imaging plane, has become an essential tool for investigating a wide variety of biological problems from developmental questions to neuroscience (J. Huisken et al., Science 305, (2004): 1007; M. B. Ahrens et al., Nat. Methods 10, (2013): 413). Light Sheet Microscopy is attractive due to its excellent optical sectioning in thick samples, and low phototoxicity which can allow imaging over multiple days and high frame rates, allowing both time lapse movies of embryo development and mapping neural circuits. A variety of LSMs have been developed for a range of applications. LSMs capable of imaging larger samples typically have resolutions from 500 nm to 2 microns with the axial resolution being worse, and volumetric imaging rates up to 10 volumes per second. A significant problem with many LSM geometries is shadowing or striping in light sheet images (J. Huisken & D. Y. R. Stainier, Optics Lett. 32, (2007): 2608; A. K. Glaser et al., Sci Rep. 8, (2018): 13878; Y. Liu, J. D. Lauderdale & P. Kner, Optics Lett. 44, (2019): 2510-2513). With the light-sheet incident from only one direction, any occlusions in the light sheet path will result in a weaker fluorescent signal behind the occlusion. To solve this problem, the light-sheet direction must be varied. The light-sheet can be dithered quickly which provides partial relief, but varying the direction significantly has required multiple excitation objectives complicating the optical setup.

Several LSM geometries have been developed to image C. elegans, Drosophila and zebrafish larvae at relatively high speed and moderate resolution. Volumetric imaging of the entire Drosophila CNS has been achieved with the high-speed Simultaneous Multi-View (hs-SiMView) system at 5 volumes per second for up to an hour (W. C. Lemon et al., Nat. Commun. 6, (2015): 7924). For this work, the resolution was estimated to be 1.6 μm laterally by 5.9 μm axially for 2nd instar larvae. This system uses 4 objectives to alternate between orthogonal light sheet direction so that a close to isotropic resolution of 1.6 μm should be possible albeit at slower speed. This system can image volumes up to 800×800×250 μm³. Swept Confocally Aligned Planar Excitation (SCAPE) microscopy can image at up to 10 volumes per second (M. B. Bouchard et al., Nat. Phot. 9, (2015): 113; V. Voleti et al., Nat. Methods 16, (2019): 1054). SCAPE has been used to image 600×650×134 μm³ volumes at 10 volumes per second. In this approach a single objective is used, and the light sheet is swept diagonally, with respect to the objective, across the volume. The single-objective approach is attractive because the sample mounting is considerably easier than in the hs-SiMView configuration, and the high speed allows for imaging of freely moving animals. The resolution of this approach varies from 2 μm×2 μm×5 μm down to 0.5 μm×1.5 μm×2 μm, with the resolution varying across the volume and with the particular configuration.

Dual View Inverted Light Sheet Microscopy (diSPIM) achieves a quasi-isotropic resolution of 330 nm over a volume of 330×330×330 μm³ (Y. Wu et al., Proc. Natl. Acad. Sci. U.S.A. 108, (2011): 17708; Y. Wu et al., Nat. Biotechnol. 31, (2013): 1032-1038). Imaging can be done at 200 frames per second. This results in imaging a volume of 100×100×100 μm³ at 2 volumes per second. The diSPIM also uses an upright imaging geometry in which samples are mounted on slides. Another method for achieving isotropic sub-micron resolution is the Axially Swept Light-Sheet Microscope (ASLM) (K. M. Dean et al., Biophys. J. 108, (2015): 2807; T. Chakraborty et al., Nat. Methods 16, (2019): 1109). In ASLM, a very tight Gaussian light-sheet with a sub-micron beam waist is swept across the sample and synchronized with the rolling shutter of the sCMOS camera. With this design, an isotropic resolution of 480 nm (before any deconvolution) has been achieved over a 327×327 μm² field of view. This approach uses a two-objective design and cannot solve problems with shadowing artifacts. Because of the synchronization with the rolling shutter, the effective exposure time for any given pixel is very small so high powers are required.

Structured Illumination Microscopy (SIM), which increases the resolution by a factor of two, has been combined with LSM to increase the resolution. Isotropic resolution enhancement has however not been achieved due to the difficulty in creating structured illumination patterns in varying directions. The Lattice Light Sheet Microscope (LLSM) (B. C. Chen et al., Science 346, (2014): 1257998) is the only widely adopted microscope to use structured illumination (SI) to increase resolution. With SI, the LLSM achieves an impressive resolution of 150 nm×230 nm×280 nm over a volume of roughly 100×100×100 μm³. The LLS Microscope has been used to image zebrafish embryos up to 96 hours post fertilization (T. L. Liu, et al., Science 360, (2018): eaaq1392). The LLSM uses a two-objective light sheet configuration which limits the SI pattern to one orientation. The other approach to combine light sheet microscopy with structured illumination is the coherent structured illumination LSM (csiLSFM) (B. J. Chang, V. D. Perez Meza & E. H. K. Stelzer, Proc. Natl. Acad. Sci. 114, (2017): 4869). The csiLSFM uses counterpropagating beams to create a standing wave pattern. The csiLSFM can achieve close to isotropic 100-nm resolution in the lateral plane, but the axial resolution is still ˜880 nm. This system has not been widely adopted.

In order to fully take advantage of SIM, a set of illumination patterns with multiple orientations is needed. LLSM is not designed to achieve sub-cellular resolution while maintaining large field of view, rendering it insufficient for certain research endeavors. For example, LLSM cannot resolve individual axons while also viewing the entire mid-brain of the zebrafish larva. In order to differentiate between individual overlapping axons in the larval zebrafish central nervous system, the resolving power of an imaging system should be less than 200 nm, because the diameter of these axons is around 400 nm. Further, the above solutions require complicated sample mounting procedures. The cost and complexity of these systems makes them practically inaccessible.

In view of these limitations of existing microscopy systems, there is a need for an improved instrument, e.g., one that provides sub-diffraction resolution throughout fruit flies, zebrafish embryos, and other model organisms. The present disclosure addresses this and other needs by providing a microscope and associated methods having improved performance when used to image such thick samples.

### BRIEF SUMMARY

The present disclosure generally relates to an improved light sheet microscope that enables multidirectional illumination over 360°, allowing for, as an example, imaging of thick multi-cellular specimens at high resolution. The improved microscope system can be combined with structured illumination microscopy and can solve problems associated with isotropic lateral structured illumination as well as mitigate striping and shadowing artifacts. The system can provide high lateral resolutions, e.g., resolutions below 220 nm, over large sample volumes in an upright geometry. The system can also provide volumetric imaging at 0.5 to 5 volumes per second, which is fast enough for many applications in neuroscience and developmental biology.

In one aspect, the disclosure is to a microscope for imaging a sample within a sample volume. The microscope includes a laser configured to emit an illumination light. The microscope further includes a beam shaper configured to generate a light sheet from the illumination light. The microscope further includes an objective lens having an optical axis. The objective lens is configured to transmit the light sheet to and transmit detection light exiting from the sample volume. The microscope further includes two or more reflectors each located in a different position in a sample plane that transects the sample volume orthogonal to the optical axis. The microscope further includes a beam steering mirror. The microscope further includes a steering motor configured to move the beam steering mirror to each of two or more positions. At each of the two or more positions the beam steering mirror is configured to steer the light sheet through the objective lens to a different selected reflector of the two or more reflectors, such that the light sheet is reflected from the selected reflector through the sample volume. The microscope further includes an imager configured to image the detection light transmitted by the objective lens.

In another aspect, the disclosure is to a method for imaging a sample within a sample volume with a microscope. The method includes emitting an illumination light using a laser. The method further includes generating a light sheet from the illumination light using a beam shaper. The method further includes transmitting the light sheet through an objective lens to a first reflector of two or more reflectors. The objective lens has an optical axis, and each of the two or more reflectors is located in a different position in a sample plane that transects the sample volume orthogonal to the optical axis. The method further includes directing the light sheet through the sample volume and substantially in the sample plane using the first reflector. The method further includes detecting a first detection light using an imager. The first detection light exits the sample volume as the light sheet is directed with the first reflector. The first detection light is transmitted through the objective lens to the imager. The method further includes moving a beam steering mirror such that the moved beam steering mirror steers the light sheet such that upon exiting the objective lens the light sheet is directed to a second reflector of the two or more reflectors. The method further includes detecting a second detection light using the imager. The second detection light exits the sample volume as the light sheet is directed with the second reflector, The second detection light is transmitted through the objective lens to the imager.

### BRIEF DESCRIPTION OF THE DRAWINGS

FIG. 1 is an illustration of three prism reflectors, each reflecting a light sheet in a different direction through a sample volume of a microscope in accordance with a provided embodiment.

FIG. 2 is a side-view illustration of the placement of three prism reflectors below the objective lens of a microscope in accordance with a provided embodiment.

FIG. 3 is an overhead-view illustration of the relative placement of three reflectors of a microscope in accordance with a provided embodiment.

FIG. 4 is an overhead-view illustration of three 500-μm prism reflectors fit within the imaging volume of a microscope in accordance with a provided embodiment.

FIG. 5 is an isometric-view illustration of three 500-μm prism reflectors fit within the imaging volume of a microscope in accordance with a provided embodiment.

FIG. 6 is an illustration of the tip and tilt of a light sheet with respect to the sample plane of a microscope in accordance with a provided embodiment.

FIG. 7 is a schematic diagram of the optical setup of a microscope in accordance with a provided embodiment. SM1 and SM2: steering mirrors for aligning and changing the light sheet direction. TL: tube lens. FM: focus mirror which adjusts the beam waist of the excitation beam. PR: polarization rotator. WP: waveplate. SLM1: phase-only 512×512 spatial light modulator. SLM2: ferroelectric 2048×2048 spatial light modulator. An additional objective (not shown) can be mounted below the stage so that phase imaging techniques can be used to assist in locating the sample.

FIG. 8 presents illustrations of a prism mounting design in accordance with a provided embodiment. The left image shows the objective, prisms, and a 30-mm sample dish. The right image shows a closeup of the prisms.

FIG. 9 is a schematic diagram of the optical setup of a microscope in accordance with a provided embodiment. A Nikon 16× 0.8-NA water dipping objective was used as the illumination as well as the imaging objective lens, and a 0.6-NA 50× Nikon air objective lens was used to construct the remote focusing system. L1: 300 mm, L2=L4=L5=L8: 100 mm, L3: 80 mm, L6: 75 mm, L7: 30 mm, L10: 150 mm, L11: 200 mm, L12: 35 mm, L13: 50 mm, T1: 35 mm, 150 mm, T2: 125 mm, 250 mm, T4: 100 mm, 100 mm, T3=T5: 200 mm, 200 mm, CL: 100 mm.

FIG. 10 is an image showing the optical transfer function (OTF) from use of structured illumination patterns for increasing axial resolution in accordance with a provided embodiment.

FIG. 11 is an image showing the point spread function (PSF) from use of structured illumination patterns for increasing axial resolution in accordance with a provided embodiment.

FIG. 12 is a graph comparing plots of the effective PSF for structured illumination and that of a Bessel beam with 0.5 NA. The size of the PSF can be reduced further by using higher frequency structured illumination patterns requiring more images.

FIG. 13 is an illustration of a beam overlap that creates axial structured illumination patterns.

FIG. 14 shows the illumination pattern of a three-dimensional structured illumination for 180 nm×320 nm resolution.

FIG. 15 shows the PSF from one image derived with three-dimensional structured illumination for 180 nm×320 nm resolution.

FIG. 16 shows the frequency content from one image derived with three-dimensional structured illumination for 180 nm×320 nm resolution. Frequency components of the pattern are at 50% of pupil full radius.

FIG. 17 shows the effective OTF for structured illumination with a two-dimensional pattern after Wiener filtering. Scale bar is 2 μm⁻¹.

FIG. 18 shows the effective PSF in the xz-plane. Scale bar is 1 μm.

FIG. 19 is a graph comparing plots of lateral profiles using widefield or structured illumination.

FIG. 20 is a graph comparing plots of axial profiles using widefield or structured illumination.

FIG. 21 is an illustration of light sheet beam waist shifting using a microscope in accordance with a provided embodiment.

FIG. 22 is a schematic illustration of an optical design of remote focusing for a microscope in accordance with a provided embodiment.

FIG. 23 is an image of a Gaussian beam waist at a first position with a microscope in accordance with a provided embodiment.

FIG. 24 is an image of a Gaussian beam waist at a second position shifted 50 μm from the first position of FIG. 23.

FIG. 25 is an image of a Gaussian beam waist at a third position shifted 50 μm from the second position of FIG. 24.

FIG. 26 is a graph plotting normalized line intensity profiles along the illumination direction for each of the beam waist positions of FIGS. 23-25.

FIG. 27 is a graph plotting results from a simulation of the Strehl ratio as a function of point source position using 0.45 illumination NA in water for a 488-nm laser.

FIG. 28 is a diagram of optical ray tracing of a remote focusing system without axial shift. This simulation traces rays from the conjugated image plane (SLM) to the lens in front of tip-tilt mirror that is conjugate to the front focal plane of the illumination objective lens. The optics include a 200-mm lens (D=1 inch), a pair of 50× objective lenses, 150 mm, a set of 200-mm lenses, a 100-mm lens that is 2 inch in diameter, and then a 30-mm and a 75-mm lens with 1-inch diameter.

FIG. 29 is a diagram of optical ray tracing of the remote focusing system of FIG. 28, but with 750-μm axial shift.

FIG. 30 shows a microscope synchronization trigger sequence for binary SLM amplitude modulation of the illumination light.

FIG. 31 presents images of a 5-μm thick light sheet created using SLM only (left) and a 5-μm thick light sheet created using a cylindrical lens and SLM (right).

FIG. 32 is a graph plotting line intensity profiles for both cases shown in FIG. 31.

FIG. 33 presents illustrations of light modulation of the SLM for multidirectional illumination.

FIG. 34 presents diagrams showing the excitation beam in the objective back pupil plane for a light sheet in each of the three beam directions illustrated in FIG. 33.

FIG. 35 presents images of light sheet profiles for three illumination directions.

FIG. 36 presents images of illumination with the light sheet profiles of FIG. 35.

FIG. 37 is a graph plotting a normalized line intensity profile of the light sheet thickness for each of the three different angles of FIGS. 35 and 36. FWHM 4.768+/−0.177 μm.

FIG. 38 is a graph plotting a normalized line intensity profile of the light sheet width for each of the three different angles of FIGS. 35 and 36. FWHM 63.93+/−4.76 μm.

FIG. 39 presents illustrations of the imaging area coverage of a microscope in accordance with a provided embodiment. The dotted inner circle of the left illustration indicates the conventional single-direction light sheet coverage, and the outer dotted circle indicates the multidirectional imaging area coverage. The right illustration shows the overlap of the three illumination angles.

FIG. 40 presents images comparing multidirectional illumination coverage (right) with single-illumination light sheet imaging area coverage (left).

FIG. 41 presents images of lateral and axial point spread functions for a microscope in accordance with a provided embodiment.

FIG. 42 is a box plot of 10 measurements of the lateral and axial profiles of the point spread functions of FIG. 41.

FIG. 43 is a graph plotting representative horizontal and vertical line profiles of the lateral point spread function of FIG. 42.

FIG. 44 is a graph plotting a representative line profile of the axial point spread function of FIG. 42.

FIG. 45 presents images of maximum intensity projection of a 20-μm image stack of a 7-day organoid with multi-angle illumination (left) and a unidirectional illumination light sheet (right).

FIG. 46 presents images showing a maximum intensity projection of a 50-μm image stack with each of three directions of light sheet illumination (A-C), with the arrows indicating the illumination direction of the light sheet, as well as the fused image (D) with multidirectional illumination. Scale bar is 50 μm in (D).

FIG. 47 presents images of structured illumination with light sheet fluorescence microscopy in three orientations and three phases in accordance with a provided embodiment.

FIG. 48 is a graph plotting the line intensity profile of the structured illumination of FIG. 47.

FIG. 49 presents a comparison of imaging fluorescent beads using LSFM (left) and SIM-LSFM (right).

FIG. 50 is a graph plotting the normalized line intensity profile for two beads in the images of FIG. 49.

FIG. 51 presents images showing the illumination patterns at the back pupil plane of the excitation path in a simulation of an optical lattice light sheet as applied to a microscope in accordance with a provided embodiment.

FIG. 52 presents images showing the intensity patterns at the front focal plane for the lattice light sheets of FIG. 51.

FIG. 53 presents images showing the effective point spread functions for the lattice light sheets of FIG. 51.

FIG. 54 presents images showing the optical transfer functions for the lattice light sheets of FIG. 51.

### DETAILED DESCRIPTION OF THE INVENTION

### I. General

The present disclosure provides a light sheet microscopy system that allows for multi-directional illumination of a sample volume through a single objective. The provided microscopy system can be optionally combined with structured illumination, and can advantageously provide deep sample penetration and high isotropic resolution. While existing light sheet fluorescence microscopy (LSFM) instruments and techniques can provide good temporal resolution and optical sectioning for high-speed imaging of live samples over a large field of view (FOV), the image quality obtained using these existing approaches is strongly affected by sample size and thickness. In particular, the geometry of LSFM limits the resolution to the cellular level laterally and reduces its resolution by a factor of 3 axially. Further improvement of axial resolution with these existing instruments typically comes at the cost of FOV. The microscope and methods disclosed herein overcome these and other limitations by applying multidirectional illumination through a single objective.

The microscope disclosed herein operates by using multiple reflective surfaces to create a light sheet illuminating a cross-section of a sample volume. Although other instruments have also utilized light sheet reflection approaches (R. Galland et al., Nat. Methods 12, (2015): 641; E. Zagato et al., Optics Express 25, (2017): 1732; A. B. Kashekodi et al., Biomed. Optics Express 9, (2018): 4263; M. B. M. Meddens et al., Biomed. Optics Express 7, (2016): 2219), the current design benefits from a surprisingly advantageous innovation of using two or more reflective surfaces to direct the light sheet in multiple orientations. More specifically, the provided microscope includes components for steering the beam to two or more different reflectors, e.g., reflective prisms, with a tip/tilt mirror. This allows for the creation of patterns at different orientations, so that isotropic SIM can beneficially be achieved, and the SIM data that is generated is more robust to stripe artifacts induced by the sample structures.

The provided microscope and related methods also provide several other key advantages for imaging live samples over volumes on the order of 300×300×300 μm³. The design of the microscope allows for easy sample mounting, enabling higher imaging throughput and simplified live cell imaging. The microscope can produce higher resolution than that achievable with existing light sheet microscopy approaches in the imaging of large samples. By using structured illumination, the provided system can provide isotropic resolution of, for example, 320 nm, or use a full structured illumination approach to provide resolution of, for example, 180 nm×180 nm×300 nm. The multidirectional illumination allows for isotropic resolution improvement in the lateral direction. The illumination geometry within the provided microscope is also compatible with many complementary developments in light-sheet imaging such as the use of a Bessel beam and lattice-light sheet excitation. Additionally, the provided microscope design is relatively simple and inexpensive relative to existing multidirectional light sheet microscopes, and can be constructed using, for example, commercially available micro-prisms and objective lenses.

### II. Definitions

As used herein, the term “substantially” refers to a value or property that deviates from ideality by +/−10%. For example, values that are “substantially equal” to one another differ from one another by less than 10%. Additionally, a direction that is “substantially in” a certain plane has an angle of separation from the plane that is less than 10%.

As used herein, the terms “including,” “comprising,” “having,” “containing,” and variations thereof, are inclusive and open-ended and do not exclude additional, unrecited elements or method steps beyond those explicitly recited. As used herein, the phrase “consisting of” is closed and excludes any element, step, or ingredient not explicitly specified. As used herein, the phrase “consisting essentially of” limits the scope of the described feature to the specified materials or steps and those that do not materially affect the basic and novel characteristics of the disclosed feature.

As used herein, the singular forms “a,” “an,” and “the” include plural referents unless the content clearly dictates otherwise. Thus, for example, reference to “a polymer” optionally includes a combination of two or more polymers, and the like.

As used herein, the term “about” denotes a range of value that is +/−10% of a specified value. For instance, “about 10” denotes the value range of 9 to 11 (10+/−1).

The terms “first,” “second,” “third,” and the like, when used herein with reference to mirrors, reflectors, or other elements or properties of the provided embodiments, are simply to distinguish the two or more elements or properties and are not intended to indicate order.

### III. Microscopes

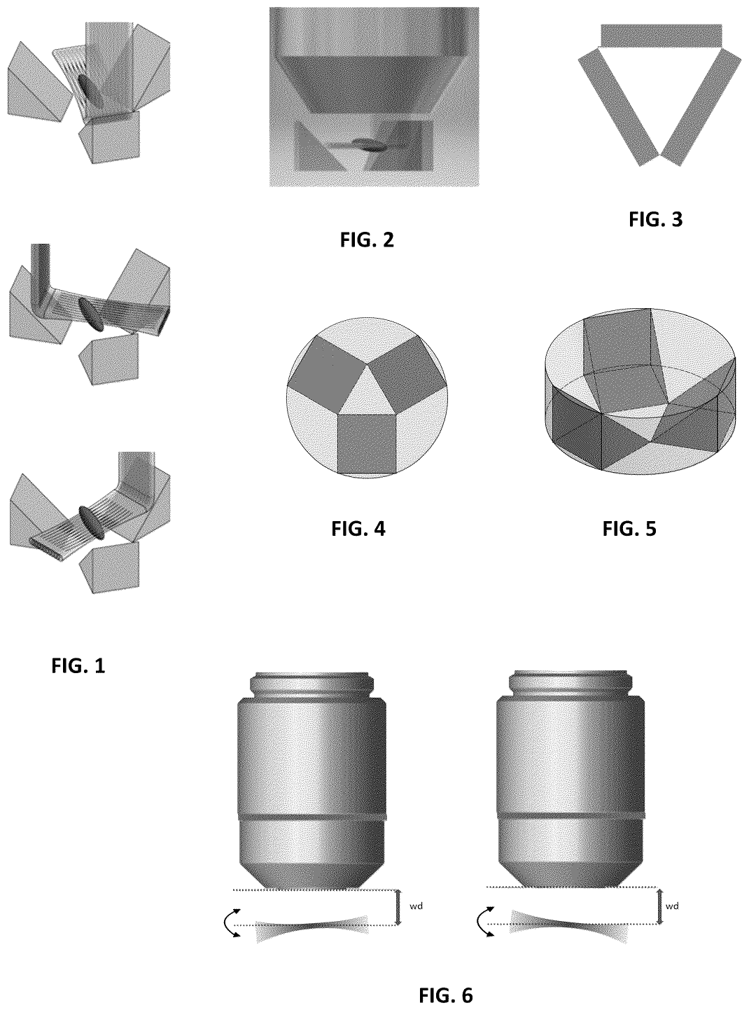

In one aspect, the present disclosure provides various microscopes for imaging a sample within a sample volume. Each provided microscope generally includes two or more reflectors that are each located in a different position about the sample volume, and that are each configured to reflect a light sheet through the sample volume. Advantageously, a single objective lens is used as both the illumination and the detection objective lens simplifying the microscope design and reducing its production cost. The reflectors are used to direct the illuminating sheet laterally at the sample plane so that the beam is coaligned with the focal plane of the objective. The light sheet is directed to one of the reflectors at a time using a fast-steering mirror, and the beam (or beams for structured illumination) are rotated so that the light sheet will travel through the field of view in the imaging plane (FIG. 1). Unlike more “traditional” multi-objective light sheets, this provided configuration allows for multidirectional light sheet illumination with faster switching times and less hardware. The provided microscope configuration also allows for isotropic structured illumination, which has been a challenge for other light sheet geometries. In some embodiments, the provided microscope is a multidirectional light sheet fluorescence microscope (LSFM), such that the illumination light includes a fluorescence excitation light, and detection light imaged by an imager of the microscope includes fluorescence emission light.

FIGS. 1-5 illustrate an exemplary configuration of three micro-prisms used as reflectors to direct the light sheet from multiple directions. The prisms in this example are positioned 120 degrees apart from each other. The prisms are also sized and positioned appropriately to fit into the field of view of the objective lens, so that the illumination area and imaging depth in the system are sufficient to image thick, multi-cellular specimens. The exemplary configuration illustrated in FIGS. 1-5 includes three 500-μm prisms, positioned as an equilateral triangle. This allows for an imaging volume with a depth of 500 μm, as shown in FIG. 5. While the configuration of reflectors shown in FIGS. 1-5 includes three reflectors, other geometries including two or more reflectors can also be used to allow either more or fewer illumination directions.

In some embodiments, and as shown in FIGS. 1-5, the two or more reflectors are positioned such that the distance from each of the two or more reflectors to the optical axis, i.e., the center of the field of view of the objective lens, is substantially equal. In some embodiments, the two or more reflectors are positioned such that the angular separations of the two or more reflectors about the optical axis are substantially equal. In other words, three reflectors are positioned 120 degrees apart from one another, four reflectors are positioned 90 degrees from one another, five reflectors are positioned 72 degrees apart from one another, and N reflectors are positioned 360/N degrees apart from one another. In this way, the two or more reflectors are positioned with discrete axial symmetry about the optical axis of the optical axis of the objective lens. The geometry of the reflectors allows for combination with many different advances in light sheet microscope. For example, the system can be used with Bessel beams, two-photon excitation, lattice light sheet, magic carpet beams, etc. In some embodiments, the reflectors are used with Gaussian light sheets or structured illumination approaches.

In some embodiments, at least one of the two or more reflectors of the provided microscope is a prism, e.g., a prism having a reflective surface. In some embodiments, each of the two or more reflectors is a prism. In some embodiments, at least one of the two or more reflectors of the provided microscope is a mirror. In some embodiments, each of the two or more reflectors is a mirror. In some embodiments, at least one of the two or more reflectors of the provided microscope is a beam splitter. In some embodiments, each of the two or more reflectors is a beam splitter.

In some embodiments, the microscope includes a sample stage for supporting and moving, e.g., translating, the sample to be imaged, and each of the two or more reflectors is attached to the sample stage. In this way, the reflectors move with the sample stage as the sample stage is translated relative to other components of the microscope, such as the objective lens. In some embodiments, each of the two or more reflectors is attached to the objective lens of the microscope, such that the reflectors move with the objective lens as the objective lens is translated relative to other components of the microscope, such as the sample. In some embodiments, each of the two or more reflectors is attached to a separate structure, e.g., a robotic arm, that can be lowered into place after a sample has been located within the field of view of the microscope objective lens.

In some embodiments, the microscope further includes a remote focuser. The remote focuser of the microscope can be used to address an issue associated with the limited length of the light sheet. For configurations in which the beam waist of the light sheet would be positioned at the reflector, the effective area of the sample being illuminated by the light sheet is only half of the Rayleigh range. Therefore, illumination can be improved by shifting the beam waist to the center of the imaging area. Remote focusing can accomplish this by adjusting the beam waist with minimal introduction of aberrations (T. Chakraborty et al., Nat. Methods 16, (2019): 1109; E. J. Botcherby et al., Opt. Lett. 32, (2007): 2007). In particular, the remote focuser can position the beam waist of the light sheet substantially at an intersection of the sample plane and the optical axis of objective lens.

To direct the light sheet to the different reflectors of the provided microscope as the light sheet exits the objective lens, the microscope includes a beam steering mirror. The beam steering mirror is moved with a steering motor configured to, for example, pivot the steering mirror among two or more positions. At each of these two or more positions, the beam steering mirror steers the light sheet through the objective lens and towards a different selected reflector of the two or more reflectors (FIG. 1). In some embodiments, the beam steering mirror is conjugate to the front focal plane of the objective lens.

In some embodiments, the provided microscope further includes a second beam steering mirror used to adjust the orientation of the light sheet as it impinges upon and reflects off of each of the two or more reflectors of the microscope. The second beam steering mirror can be moved by a second steering motor configured to, for example, pivot the second steering motor. By thus moving the second beam steering mirror, the mirror can be used to adjust the tip and/or tilt of the light sheet within the imaging volume (FIG. 6). In particular, the moved second beam steering mirror can be used to steer the light sheet such that the selected reflector directs the light sheet through the sample volume and substantially in the sample plane. In some embodiments, the second beam steering mirror is conjugate to the back pupil plane of the objective lens.

In some embodiments, the provided microscope further includes a beam structurer used to add structure to the light sheet. A variety of structured illumination patterns can be used in both the lateral and the axial directions to balance the tradeoff between resolution and time (with higher resolutions requiring more patterns). In some embodiments, the structured illumination is created by interfering two or more light beams, e.g., Gaussian light beams. In some embodiments, the beam structurer creates a lattice light sheet (LLS).

In some embodiments, the beam structurer of the provided microscope includes one or more spatial light modulators. The spatial light modulators can allow for flexible generation of different structured illumination patterns and beam profiles so that different structured illumination modes can be employed. In some embodiments, the microscope includes a spatial light modulator (SLM) that is a binary microdisplay, which means that each pixel of the SLM can exist in only one of two states, on or off. In some embodiments, at least one of the spatial light modulators of the beam structurer is a ferro-electric binary spatial light modulator. In some embodiments, each spatial light modulator of the beam structurer is a ferro-electric binary spatial light modulator. In some embodiments, at least one of the spatial light modulators of the beam structurer is conjugate to the sample plane. In some embodiments, the beam structurer further includes a polarized beam splitter.

Because the light sheet of the provided microscope is to be directed using two or more reflectors that are mounted at different positions in the focal plane of the objective lens, the beam must be oriented to the correct direction for each different reflector. In some embodiments, the beam orientation is corrected using a spatial light modulator. In some embodiments, a spatial light modulator of the microscope is operated in an amplitude modulation mode, and the orientation of the light sheet is changed by switching the display pattern on the spatial light modulator. An advantage of this approach is a rapid switching of the illumination angle. In some embodiments, the rapid switching of the light sheet orientation using a spatial light modulator is achieved using a microcontroller board.

In some embodiments, a beam shaper of the provided microscope includes a cylindrical lens, e.g., an achromatic cylindrical lens, where the cylindrical lens is used to orient the beam direction for each reflector. In some embodiments, the beam shaper includes a rotation stage and/or a rotational motor configured to rotate the cylindrical lens. The rotation of the cylindrical lens, e.g., to predetermined positions, can rotate the light sheet such that the light sheet is oriented to the correct direction for each of the two or more reflectors of the microscope. An advantage of this approach is that the cylindrical lens permits high light throughput that can then be, for example, focused onto a spatial light modulator for structuring the light sheet.

In some embodiments, the thickness of the line profile of the light sheet of the provided microscope is between 1 μm and 100 μm, e.g., between 1 μm and 16 μm, between 1.6 μm and 25 μm, between 2.5 μm and 40 μm, between 4 μm and 63 μm, or between 6.3 μm and 100 μm. In terms of upper limits, the line profile thickness of the light sheet can be, for example, less than 100 μm, e.g., less than 63 μm, less than 40 μm, less than 25 μm, less than 16 μm, less than 10 μm, less than 6.3 μm, less than 4 μm, less than 2.5 μm, or less than 1.6 μm. In terms of lower limits, the line profile thickness of the light sheet can be, for example, greater than 1 μm, e.g., greater than 1.6 μm, greater than 2.5 μm, greater than 4 μm, greater than 6.3 μm, greater than 10 μm, greater than 16 μm, greater than 25 μm, greater than 40 μm, or greater than 63 μm. Larger thicknesses, e.g., greater than 100 μm, and smaller thicknesses, e.g., less than 1 μm, are also contemplated.

In some embodiments, the width of the line profile of the light sheet of the provided microscope is between 10 μm and 5 mm, e.g., between 10 μm and 420 μm, between 19 μm and 770 μm, between 35 μm and 1.4 mm, between 65 μm and 2.7 μm, or between 120 μm and 5 mm. In terms of upper limits, the line profile width of the light sheet can be, for example, less than 5 mm, e.g., less than 2.7 mm, less than 1.4 mm, less than 770 μm, less than 420 μm, less than 220 μm, less than 120 μm, less than 65 μm, less than 35 μm, or less than 19 μm. In terms of lower limits, the line profile width of the light sheet can be, for example, greater than 10 μm, e.g., greater than 19 μm, greater than 35 μm, greater than 65 μm, greater than 120 μm, greater than 220 μm, greater than 420 μm, greater than 770 μm, greater than 1.4 mm, or greater than 2.7 mm. Larger widths, e.g., greater than 5 mm, and smaller widths, e.g., less than 10 μm, are also contemplated.

In some embodiments, the length of the line profile of the light sheet of the provided microscope is between 6.5 μm and 6.5 mm, e.g., between 6.5 μm and 410 μm, between 13 μm and 820 μm, between 26 μm and 1.6 mm, between 52 μm and 3.3 mm, or between 100 μm and 6.5 mm. In terms of upper limits, the line profile length of the light sheet can be, for example, less than 6.5 mm, e.g., less than 3.3 mm, less than 1.6 mm, less than 820 μm, less than 410 μm, less than 210 μm, less than 100 μm, less than 52 μm, less than 26 μm, or less than 13 μm. In terms of lower limits, the line profile length of the light sheet can be, for example, greater than 6.5 μm, e.g., greater than 13 μm, greater than 26 μm, greater than 52 μm, greater than 100 μm, greater than 210 μm, greater than 410 μm, greater than 820 μm, greater than 1.6 mm, or greater than 3.3 mm. Larger lengths, e.g., greater than 6.5 mm, and smaller lengths, e.g., less than 6.5 μm, are also contemplated.

In some embodiments, the numerical aperture of the objective lens of the provided microscope is between 0.3 and 1.3, e.g., between 0.3 and 0.9, between 0.4 and 1, between 0.5 and 1.1, between 0.6 and 1.2, or between 0.7 and 1.3. In terms of upper limits, the numerical aperture of the objective lens can be, for example, less than 1.3, e.g., less than 1.2, less than 1.1, less than 1, less than 0.9, less than 0.8, less than 0.7, less than 0.6, less than 0.5, or less than 0.4. In terms of lower limits, the numerical aperture of the objective lens can be, for example, greater than 0.3, e.g., greater than 0.4, greater than 0.5, greater than 0.6, greater than 0.7, greater than 0.8, greater than 0.9, greater than 1, greater than 1.1, or greater than 1.2. Larger numerical apertures, e.g., greater than 1.3, and smaller numerical apertures, e.g., less than 0.3, are also contemplated.

In some embodiments, the diameter of the field of view of the provided microscope is between 125 μm and 1.5 mm, e.g., between 125 μm and 560 μm, between 160 μm and 710 μm, between 210 μm and 910 μm, between 260 μm and 1.2 mm, or between 340 μm and 1.5 mm. In terms of upper limits, the diameter of the field of view can be, for example, less than 1.5 mm, e.g., less than 1.2 mm, less than 910 μm, less than 710 μm, less than 560 μm, less than 430 μm, less than 340 μm, less than 260 μm, less than 210 μm, or less than 160 μm. In terms of lower limits, the diameter of the field of view can be, for example, greater than 125 μm, e.g., greater than 160 μm, greater than 210 μm, greater than 260 μm, greater than 340 μm, greater than 430 μm, greater than 560 μm, greater than 710 μm, greater than 910 μm, or greater than 1.2 mm. Larger diameters, e.g., greater than 1.5 mm, and smaller diameters, e.g., less than 125 μm, are also contemplated.

In some embodiments, the resolution in all lateral directions for the image produced with the provided microscope is between 100 μm and 1000 μm, e.g., between 100 μm and 640 μm, between 190 μm and 730 μm, between 280 μm and 820 μm, between 370 μm and 910 μm, or between 460 μm and 1000 μm. In terms of upper limits, the lateral resolution of the image can be, for example, less than 1000 μm, e.g., less than 910 μm, less than 820 μm, less than 730 μm, less than 640 μm, less than 550 μm, less than 460 μm, less than 370 μm, less than 280 μm, or less than 190 μm. In terms of lower limits, the lateral resolution of the image can be, for example, greater than 100 μm, e.g., greater than 190 μm, greater than 280 μm, greater than 370 μm, greater than 460 μm, greater than 550 μm, greater than 640 μm, greater than 8730 μm, greater than 820 μm, or greater than 910 μm. Higher lateral resolutions, e.g., greater than 1000 μm, and lower lateral resolutions, e.g., less than 100 μm, are also contemplated.

In some embodiments, the axial resolution for the image produced with the provided microscope is between 0.2 μm and 10 μm, e.g., between 0.2 μm and 2.1 μm, between 0.3 μm and 3.1 μm, between 0.44 μm and 4.6 μm, between 0.65 μm and 6.8 μm, or between 0.96 μm and 10 μm. In terms of upper limits, the axial resolution of the image can be, for example, less than 10 μm, e.g., less than 6.8 μm, less than 4.6 μm, less than 3.1 μm, less than 2.1 μm, less than 1.4 μm, less than 0.96 μm, less than 0.65 μm, less than 0.44 μm, or less than 0.2 μm. In terms of lower limits, the axial resolution of the image can be, for example, greater than 0.2 μm, e.g., greater than 0.3 μm, greater than 0.44 μm, greater than 0.65 μm, greater than 0.96 μm, greater than 1.4 μm, greater than 2.1 μm, greater than 3.1 μm, greater than 4.6 μm, or greater than 6.8 μm. Higher axial resolutions, e.g., greater than 10 μm, and lower axial resolutions, e.g., less than 0.2 μm, are also contemplated.

### IV. Computer Instructions and Systems

Any of the devices described herein may be totally or partially operated or performed with a computer system including one or more processors, which can be configured to perform the steps of a provided method using the disclosed devices. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

Any of the computer systems mentioned herein may utilize any suitable number of subsystems. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

A computer system can include a plurality of the same components or subsystems, e.g., connected together by external interface, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

### V. Exemplary Embodiments

The following embodiments are contemplated. All combinations of features and embodiments are contemplated.

Embodiment 1: A microscope for imaging a sample within a sample volume, wherein the microscope comprises: a laser configured to emit an illumination light; a beam shaper configured to generate a light sheet from the illumination light; an objective lens having an optical axis, wherein the objective lens is configured to transmit the light sheet to and transmit detection light exiting from the sample volume; two or more reflectors each located in a different position in a sample plane that transects the sample volume orthogonal to the optical axis; a beam steering mirror; a steering motor configured to move the beam steering mirror to each of two or more positions, wherein at each of the two or more positions the beam steering mirror is configured to steer the light sheet through the objective lens to a different selected reflector of the two or more reflectors, the light sheet reflected from the selected reflector through the sample volume; and an imager configured to image the detection light transmitted by the objective lens.

Embodiment 2: An embodiment of embodiment 1, wherein the distances from each of the two or more reflectors to the optical axis are substantially equal.

Embodiment 3: An embodiment of embodiment 1 or 2, wherein the angular separations of the two or more reflectors about the optical axis are substantially equal.

Embodiment 4: An embodiment of any one of embodiments 1-3, wherein the two or more reflectors are positioned with discrete axial symmetry about the optical axis.

Embodiment 5: An embodiment of any one of embodiments 1-4, wherein the microscope further comprises: a remote focuser configured to position a beam waist of the light sheet substantially at an intersection of the sample plane and the optical axis.

Embodiment 6: An embodiment of any one of embodiments 1-5, wherein the beam shaper comprises a cylindrical lens.

Embodiment 7: An embodiment of embodiment 6, wherein the beam shaper comprises a rotational motor configured to rotate the cylindrical lens, thereby rotating the light sheet.

Embodiment 8: An embodiment of any one of embodiments 1-7, wherein the beam steering mirror is conjugate to a front focal plane of the objective lens.

Embodiment 9: An embodiment of any one of embodiments 1-8, wherein the beam steering mirror is a first beam steering mirror, the microscope further comprising: a second beam steering mirror configured to move such that the moved second beam steering mirror steers the light sheet such that the selected reflector directs the light sheet through the sample volume and substantially in the sample plane.

Embodiment 10: An embodiment of embodiment 9, wherein the second beam steering mirror is conjugate to a back pupil plane of the objective lens.

Embodiment 11: An embodiment of any one of embodiments 1-10, wherein the microscope further comprises: a beam structurer configured to add structure the light sheet.

Embodiment 12: An embodiment of embodiment 11, wherein the beam structurer comprises a spatial light modulator.

Embodiment 13: An embodiment of embodiment 12, wherein the beam structurer comprises a polarized beam splitter.

Embodiment 14: An embodiment of embodiment 12 or 13, wherein the structure is created by an interference of two or more light beams.

Embodiment 15: An embodiment of embodiment 14, wherein each of the two or more light beams is a Gaussian light beam.

Embodiment 16: An embodiment of any one of embodiments 11-15, wherein the beam structurer adds lateral structure to the light sheet.

Embodiment 17: An embodiment of any one of embodiments 11-16, wherein the beam structurer adds axial structure to the light sheet.

Embodiment 18: An embodiment of any one of embodiments 1-17, wherein the light sheet has a line profile thickness at its beam waist that is between 1 μm and 100 μm.

Embodiment 19: An embodiment of any one of embodiments 1-18, wherein the light sheet has a line profile width at its beam waist that is between 10 μm and 5 mm.

Embodiment 20: An embodiment of any one of embodiments 1-19, wherein the light sheet has a line profile length about its beam waist that is between 6.5 μm and 6.5 mm.

Embodiment 21: An embodiment of any one of embodiments 1-20, wherein each of the two or more reflectors is attached to a sample stage of the microscope.

Embodiment 22: An embodiment of any one of embodiments 1-21, wherein each of the two or more reflectors is attached to the objective lens.

Embodiment 23: An embodiment of any one of embodiments 1-22, wherein the objective lens has a numerical aperture between 0.3 and 1.3.

Embodiment 24: An embodiment of any one of embodiments 1-23, wherein the microscope has a field of view diameter between 125 μm and 1.5 mm.

Embodiment 25: An embodiment of any one of embodiments 1-24, wherein the microscope has a lateral resolution in all lateral directions that is between 100 nm and 1 μm.

Embodiment 26: An embodiment of any one of embodiments 1-25, wherein the microscope has an axial resolution between 0.2 μm and 10 μm.

Embodiment 27: An embodiment of any one of embodiments 1-26, wherein each of the two or more reflectors independently comprises a prism having a reflective surface.

Embodiment 28: An embodiment of any one of embodiments 1-27, wherein the illumination light comprises a fluorescence excitation light, and the detection light comprises a fluorescence emission light.

Embodiment 29: A method for imaging a sample within a sample volume with a microscope, wherein the method comprises: emitting, using a laser, an illumination light; generating, using a beam shaper, a light sheet from the illumination light; transmitting the light sheet through an objective lens to a first reflector of two or more reflectors, wherein the objective lens has an optical axis, and wherein each of the two or more reflectors is located in a different position in a sample plane that transects the sample volume orthogonal to the optical axis; directing, using the first reflector, the light sheet through the sample volume and substantially in the sample plane; detecting, using an imager, a first detection light, wherein the first detection light exits the sample volume as the light sheet is directed with the first reflector, and wherein the first detection light is transmitted through the objective lens to the imager; moving a beam steering mirror such that the moved beam steering mirror steers the light sheet such that upon exiting the objective lens the light sheet is directed to a second reflector of the two or more reflectors; and detecting, using the imager, a second detection light, wherein the second detection light exits the sample volume as the light sheet is directed with the second reflector, and wherein the second detection light is transmitted through the objective lens to the imager.

Embodiment 30: An embodiment of embodiment 29, wherein the distances from each of the two or more reflectors to the optical axis are substantially equal.

Embodiment 31: An embodiment of embodiment 29 or 30, wherein the angular separations of the two or more reflectors about the optical axis are substantially equal.

Embodiment 32: An embodiment of any one of embodiments 29-31, wherein the two or more reflectors are positioned with discrete axial symmetry about the optical axis.

Embodiment 33: An embodiment of any one of embodiments 29-32, wherein the method further comprises: positioning, using a remote focuser, a beam waist of the light sheet substantially at an intersection of the sample plane and the optical axis.

Embodiment 34: An embodiment of any one of embodiments 29-33, wherein the method further comprises: rotating a cylindrical lens of the microscope, thereby rotating the light sheet.

Embodiment 35: An embodiment of any one of embodiments 29-34, wherein the beam steering mirror is conjugate to a front focal plane of the objective lens.

Embodiment 36: An embodiment of any one of embodiments 29-35, wherein the beam steering mirror is a first beam steering mirror, the method further comprising: moving a second beam steering mirror such that the moved second beam steering mirror steers the light sheet such that the second reflector directs the light sheet through the sample volume and substantially in the sample plane.

Embodiment 37: An embodiment of embodiment 36, wherein the second beam steering mirror is conjugate to a back pupil plane of the objective lens.

Embodiment 38: An embodiment of any one of embodiments 29-31, wherein the method further comprises: structuring the light sheet using a beam structurer.

Embodiment 39: An embodiment of embodiment 38, wherein the beam structurer comprises a spatial light modulator.

Embodiment 40: An embodiment of embodiment 39, wherein the beam structurer comprises a polarized beam splitter.

Embodiment 41: An embodiment of embodiment 38 or 39, wherein the structuring comprises interfering two or more light beams.

Embodiment 42: An embodiment of embodiment 41, wherein each of the two or more light beams is a Gaussian light beam.

Embodiment 43: An embodiment of any one of embodiments 38-42, wherein the structuring comprises adding lateral structure to the light sheet.

Embodiment 44: An embodiment of any one of embodiments 38-43, wherein the structuring comprises adding axial structure to the light sheet.

Embodiment 45: An embodiment of any one of embodiments 29-44, wherein the light sheet has a line profile thickness at its beam waist that is between 1 μm and 100 μm.

Embodiment 46: An embodiment of any one of embodiments 29-45, wherein the light sheet has a line profile width at its beam waist that is between 10 μm and 5 mm.

Embodiment 47: An embodiment of any one of embodiments 29-46, wherein the light sheet has a line profile length about its beam waist that is between 6.5 μm and 6.5 mm.

Embodiment 48: An embodiment of any one of embodiments 29-47, wherein each of the two or more reflectors is attached to a sample stage of the microscope.

Embodiment 49: An embodiment of any one of embodiments 29-48, wherein each of the two or more reflectors is attached to the objective lens.

Embodiment 50: An embodiment of any one of embodiments 29-49, wherein the objective lens has a numerical aperture between 0.3 and 1.3.

Embodiment 51: An embodiment of any one of embodiments 29-50, wherein the microscope has a field of view diameter between 125 μm and 1.5 mm.

Embodiment 52: An embodiment of any one of embodiments 29-51, wherein the microscope has a lateral resolution in all lateral directions that is between 100 nm and 1 μm.

Embodiment 53: An embodiment of any one of embodiments 29-52, wherein the microscope has an axial resolution between 0.2 μm and 10 μm.

Embodiment 54: An embodiment of any one of embodiments 29-53, wherein each of the two or more reflectors independently comprises a prism having a reflective surface.

Embodiment 55: An embodiment of any one of embodiments 29-54, wherein the illumination light comprises a fluorescence excitation light and the first detection light and the second detection light each independently comprise a fluorescence emission light.

Embodiment 56: A machine-readable non-transitory medium embodying information indicative of instructions for causing a computer processor to perform operations for controlling a microscope to perform the method of any one of embodiments 29-55.

Embodiment 57: A computer system for displaying images, the computer system comprising at least one processor, and a memory operatively coupled with the at least one processor, the at least one processor executing instructions from the memory comprising program code for controlling a microscope to perform the method of any one of embodiments 29-55.

### EXAMPLES

The present disclosure will be better understood in view of the following non-limiting examples. The following examples are intended for illustrative purposes only and do not limit in any way the scope of the present invention.

### Example 1. Microscope Illumination Geometry

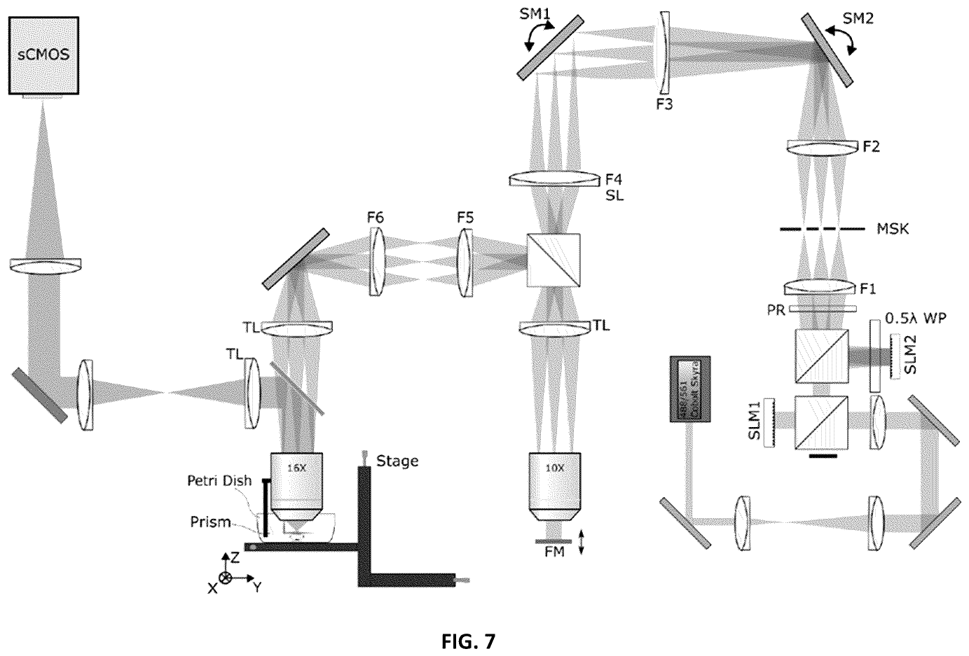

FIG. 7 illustrates the illumination geometry of one provided microscope. The illumination light of the microscope has the form of an excitation beam emitted by the 488/561 COBALT SYKRA™ laser (Hubner Photonics Skyra, 488 nm, 561 nm, 638 nm) shown in the FIG. 7. The illumination light is then expanded and first reflected off of a phase-only spatial light modulator (SLM1) conjugate to the back pupil plane. This SLM generates a lens with different focal lengths along orthogonal axes producing a 20 mm×200 μm light sheet on a ferroelectric spatial light modulator (SLM2). SLM1 is also used to correct residual aberrations in the excitation path. SLM2 is conjugate to the image plane and generates the structured illumination (SI) patterns of the illumination light. This exemplary microscope uses patterns with a period of 3 pixels in any given direction that generate patterns that fill no more than 80% of the objective back pupil plane. The field of view covered by the pattern is therefore 520 μm, greater than that covered by the imaging camera at Nyquist sampling. To rotate the illumination light beam for the correct orientation for each light sheet orientation, the focal pattern on SLM1 is rotated simultaneously with the SI pattern on SLM2. After SLM2, the polarization is also rotated to ensure maximum interference at the sample plane.

The beam is then cleaned up with a mask in a conjugate pupil plane to block out unwanted diffraction generated by the SLMs. After that, the beam is magnified and reflected off of two steering mirrors (Optotune MRE-15-30 voice-coil mirrors, large scale step response 15 ms). The first beam steering mirror (SM1) is in a conjugate pupil plane and directs the beam to each of the prism reflectors. A movement of 1.375 mm at the sample plane corresponds to 6.3 degrees in the back pupil plane. The second beam steering mirror (SM2) is conjugate to the image plane and is used to fine-tune the tip/tilt of the light sheet in the image plane. It is unlikely that the prisms will be perfectly aligned to send the light sheet directly along the image plane. After this, the beam is sent through a remote focusing setup. Remote focusing is used to allow rapid sweeping in the axial direction without aberrations (T. Chakraborty et al., Nat. Methods 16, (2019): 1109; E. J. Botcherby et al., Opt. Lett. 32, (2007): 2007). The provided microscope does not require rapid re-focusing of the excitation beam, but the excitation beam waist and pattern do benefit from shifting by 0.7 mm to lie in the center of the focal plane after bouncing off of the prisms. The remote focusing configuration allows for easy adjustment of the excitation beam waist position. Finally, the beam is sent to the sample through the tube lens (TL) and 16× objective lens.

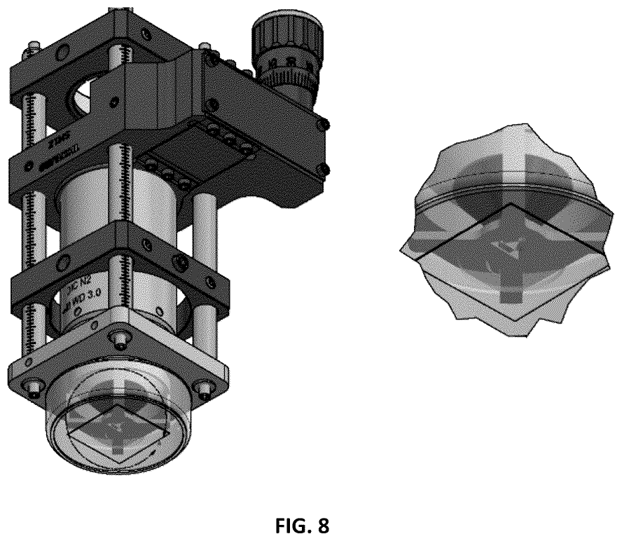

The microscope is built around a 16×0.8-NA Nikon Water Dipping objective, the CF175 LWD 16× W. FIG. 8 shows the mechanical design of the objective and prism mounting. Thus, without SI, the resolution of the microscope is 325 nm laterally and 1.625 μm in the axial direction. The working distance of the objective is 3 mm and the field of view is 1.375 mm. The prisms are placed at the edge of the field of view allowing for samples up to roughly 1 mm in extent to be imaged. The light sheet is thick enough such that twice the Rayleigh range covers roughly half the sample. Thus, to image a 330 μm×330 μm area (the field of view for a 4 MP camera), a Gaussian light sheet with a beam waist of 3.5 μm, and a Rayleigh range (πω₀²/λ) of 80 μm, are needed.

Samples are imaged in conventional 30-mm or 60-mm imaging dishes. Zebrafish or Drosophila larvae can be placed, for example, on small agarose pads to allow the prisms some leeway below the sample. A multidirectional brightfield source is placed below the dish to assist in finding the sample and generating phase images.

The emission path for the detection light of the microscope includes a dichroic mirror after the objective sending the emission beam to a second tube lens (TL). The image is then formed on a 4 Megapixel sCMOS camera (Andor Zyla 4.2). The image is sampled at the Nyquist frequency for a 0.8 NA resolution resulting in a field of view of 327×327 μm² and an effective pixel size at the sample of 160 nm. This requires an additional 2.5× magnification beyond the 16× from the objective and tube lens. The field of view is limited by the number of pixels and the Nyquist sampling requirement and can be increased with a camera with more pixels (such as the 16 MP Andor Balor sCMOS).

### Example 2. Microscope Illumination Geometry with a Cylindrical Lens

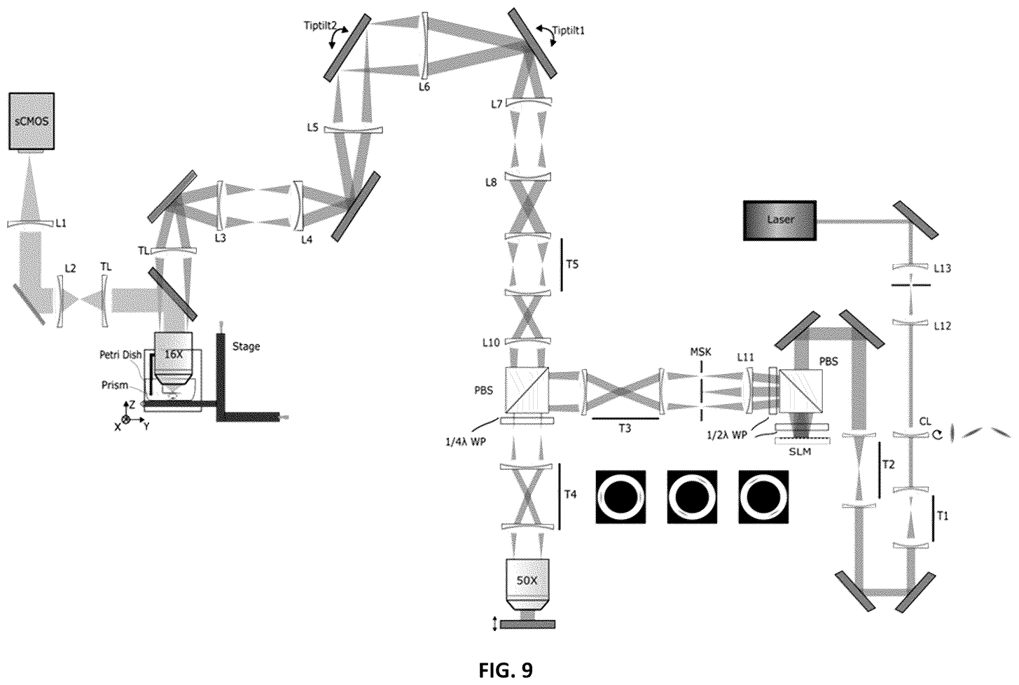

FIG. 9 illustrates the illumination geometry of another provided microscope. A COBALT SKYRA™ laser from Hubner Photonics was used, which has three wavelengths (488 nm, 561 nm, 638 nm). The laser emits a beam with a 0.7-mm diameter (1/e²), which is then focused by a 35-mm lens and filtered by a 50-μm pinhole. After the pinhole, a 50-mm lens is used to collimate the laser to 1-mm diameter. A 100-mm cylindrical lens then focuses the laser light into a line profile. The line profile has a length of 1 mm and a width of 62 μm at the focus of the cylindrical lens, according to 2ω₀=4λf/λD. The cylindrical lens is mounted on a motorized rotation stage. Additionally, a two-axis translation stage is used to adjust the position of the rotation stage. T1 (35 mm, 150 mm) and T2 (125 mm, 250 mm) are two sets of magnifying lens pairs used to enlarge the beam to 8.57 mm in length and 0.532 mm in width at the spatial light modulator (SLM). In this system, the laser light is modulated using a combination of a polarized beam splitter (PBS) and a halfwave plate together with the SLM, the SLM acting as a half-waveplate with a fast axis that switches between s-polarization and p-polarizations. L11 is a 200-mm focal length lens used to collimate the diffracted light onto the conjugated back pupil of the objective lens. A mask with an annular structure is used to block the unwanted diffraction light. Then, two sets of relay lens pairs (a T3: 200 mm and a T4: 100 mm) are used to image the diffracted light onto the back pupil of a 50×0.6 NA remote focusing objective lens (Nikon TU Plan ELWD).

In order to have the light sheet beam waist at the center of the imaging area, remote focusing is employed with a two-objective lens remote focusing configuration. A PBS with a quarter waveplate is used to ensure all of the light passes through. A mirror is placed at the front focal plane of the remote focusing objective, and mounted on a piezo stage, so that the focus for the illumination objective lens can be adjusted. L10 is a 150-mm focal length lens, and T5 includes a 200-mm focal length lens pair. The image plane of the objective lenses is transferred on to a tip tilt mirror by L8 and L7, which are 100-mm and 30-mm lenses. The mirror allows the tip and tilt of the light sheet at the front focal plane of the illumination objective lens to be adjusted. Then, a 75-mm focal length lens is used to image the conjugated back pupil plane of the objective lens onto a second tip tilt mirror, which allows for steering the beam at the front focal plane of the objective lens. This is further relayed onto the illumination objective lens using a pair of 100-mm lenses (L4 and L5) and an 80-mm lens. Here, a 200-mm tube lens is used in combination with the 16× objective lens. For the imaging path, after the 200-mm focal length tube lens (TL), the final image is magnified by a factor of 3 using a pair of lenses (L1: 300 mm, L2: 100 mm). The overall magnification from the SLM to the front focal plane of the 16× objective lens is 66.67 and the magnification between the remote focusing objective imaging plane and the illumination objective lens meets the condition of the remote focusing, which is 1.33. The overall magnification of the imaging path is 48×, giving an effective pixel size of 135 nm. The resulting imaging area on the camera is 277 μm.

### Example 3. Isotropic Resolution Imaging by Axial Structured Illumination

Because the provided microscopes use the same objective for excitation and detection, the light sheet thickness can be made as thin as the lateral resolution. Therefore, isotropic resolution can be achieved by making the light sheet as thin as possible. The problem with this approach is that then that the Rayleigh Range becomes very small—about 2 microns. Methods that have been used to solve this problem include scanning the focus of the light sheet (K. M. Dean et al., Biophys. J. 108, (2015): 2807), and using various non-diffracting beams such as the Bessel beam (T. A. Planchon et al., Nat. Meth. 8, (2011): 417) and Airy beam (T. Vettenburg et al., Nat. Meth. 11, (2014): 541). Non-diffracting beams generate significant side-lobes and scanning the focus means that the effective exposure time of the camera is much less. The provided microscope can solve this problem by applying structured illumination in the axial direction.

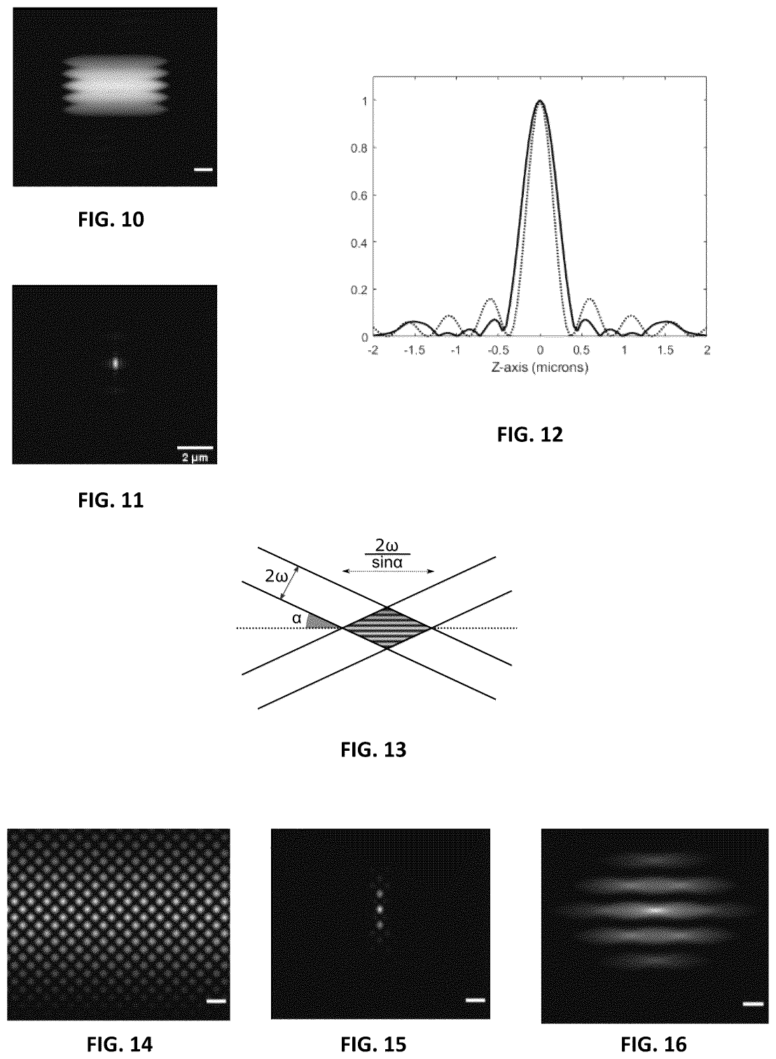

Two Gaussian beams with long Rayleigh lengths are interfered, and the interference of the two beams provides a sinusoidal pattern with a pattern wavelength down to 300 nm. By using standard structured illumination techniques, the axial resolution is increased and out-of-focus light is removed (M. G. L. Gustafsson et al., Biophys. J. 94, (2008): 4957). With three phases and a low-frequency structured illumination pattern (3λ/NA), an axial resolution of 900 nm is achieved. Increasing the frequency of the structured illumination pattern results in an effective point spread function (PSF) with sidelobes corresponding to an effective Optical Transfer Function (OTF) with gaps. It is well known that this can lead to problems with data interpretation and deconvolution (J. Bewersdorf, R. Schmidt & S. W. Hell, J. Microscopy 222, (2006): 105). Here this problem is solved by combining two illumination patterns to achieve a single-lobed PSF and continuous OTF as shown in FIGS. 10-12. These correspond to 40% and 20% of the pupil. With this configuration a 240-nm lateral by 480-nm axial resolution is achieved. The increased lateral resolution comes from the Wiener filter boosting the high frequencies. By using more of the pupil and more patterns to fill in the OTF, the axial resolution can be increased to 320 nm. On the prism, the two beams creating the interference are separated by 0.6 mm, easily fitting on the 1-mm prism without clipping. This allows imaging of a stack with a 1.6-μm Δz with 6 images per slice, but the effective axial PSF is 480 nm so three times as many slices are effectively imaged resulting in only a 2× loss of imaging speed while gaining resolution.

The beam overlap depends on the NA of the axial illumination pattern and the beam waist of the individual beams. The overlap is given by ˜2nω₀/NA according to the geometry shown in FIG. 13. Thus, for a 4-μm beam waist and a 0.4 NA, the provided microscope achieves a 27-μm overlap of the beams, effectively providing a 27×300 μm² field of view. For many applications, it is acceptable to achieve a high resolution over only a limited field of view. To increase the field of view without sacrificing axial resolution, the excitation beam waist can be increased at the expense of higher noise, or the interfering pattern can be scanned over the field.

### Example 4. Lateral Structured Illumination

Lateral resolution is improved through a lateral structured illumination pattern. The pattern wavelength is (5/4)λ/2NA giving an increase in resolution of 1.6×. This results in a lateral resolution of 180 nm. Due to the overlap of the shifted OTFs in k-space, this approach also improves optical sectioning although the axial resolution remains at 1.6 μm.

### Example 5. Full Structured Illumination for Imaging at High Resolution

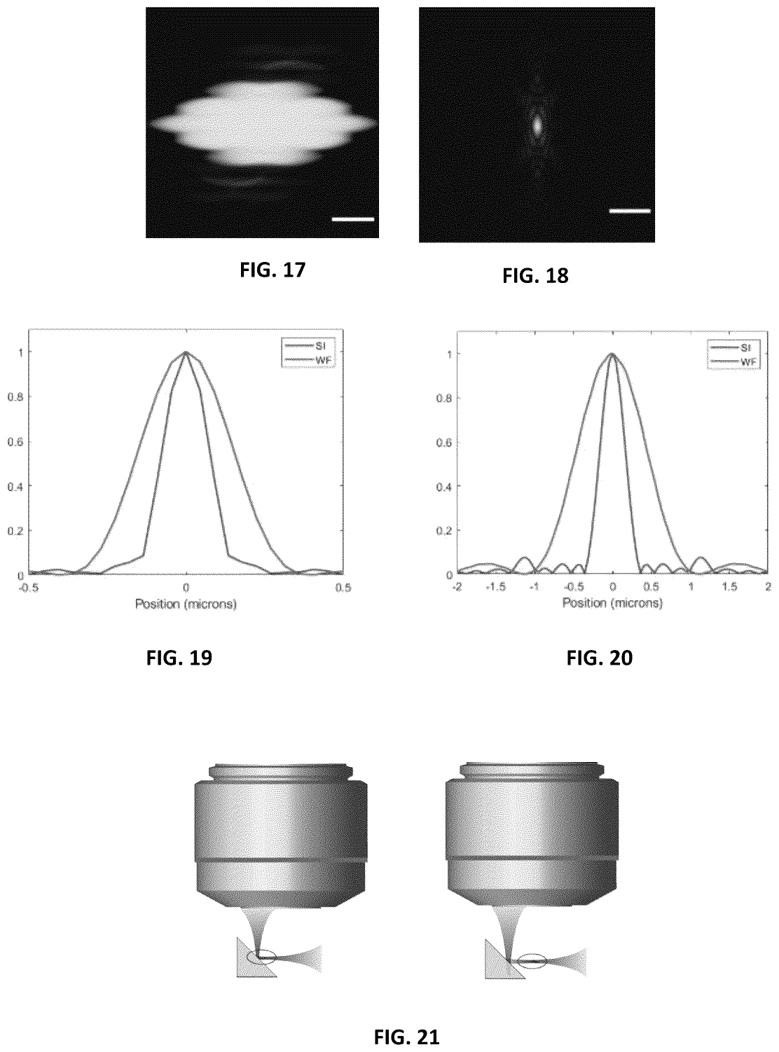

To achieve increased resolution in all three-dimensions, a square lattice is used to create structure in both the lateral and axial directions (FIGS. 14-16). A single pattern requires 7 phases to separate out the components. As can be seen in the Fourier Transform in FIG. 16, the frequency support of the pattern gives a resolution of 180 nm×360 nm. As with the axial structured illumination, the pattern leaves gaps in the frequency support. Also as with axial SI, by using another structured illumination pattern with lower axial frequency, the gaps in the OTF can be filled in as shown in FIGS. 17-20. The combination of patterns can be optimized to improve the overlap and the support of the OTF. This approach requires 14 images per structured illumination direction, so 42 images are required per axial slice (Δz=0.8 μm) to achieve isotropic lateral resolution. While this slows down imaging, not only is the resolution increased in all dimensions, but there is considerable overlap in information content between the images. This means that the exposure time can be lowered, so that the time per slice does not have to be 42 times as long but can be only 21 times as long. Imaging can still be accomplished at under 100 ms per slice for an 80 μm×160 μm field of view. Axial resolution can be improved down to 300 nm by using the full pupil at the expense of more images.

### Example 6. Volumetric Imaging

A piezoelectric objective scanner is used for fast volumetric imaging, with the light sheet moving with the objective. The objective is driven sinusoidally at 1 to 10 Hz to avoid problems with settling times required for stepping the piezo. When multiple images are taken per slice, the axial scan is first as in early implementations of structured illumination (M. G. L. Gustafsson et al., Biophys. J. 94, (2008): 4957. For volumetric imaging, the speed and volume are almost entirely determined by the required exposure time. To image the full field of view at 100 frames per second, a speed of 200 μm/s (Δz=2 μm) is used, and a 100-μm axial range can be imaged at 2 volumes per second. As the imaging gets more sophisticated, the overall volumetric rate must go down although the axial resolution will increase. For increased axial resolution with structured illumination imaging with 500-nm axial resolution, 6 images per 0.8 μm are required for a volumetric rate of 14 μm/s. Therefore, imaging a 50-μm axial range with the provided microscope requires 3.6 s, but the axial resolution is 3 times better.

### Example 7. Isotropic Resolution Imaging by Axial Structured Illumination

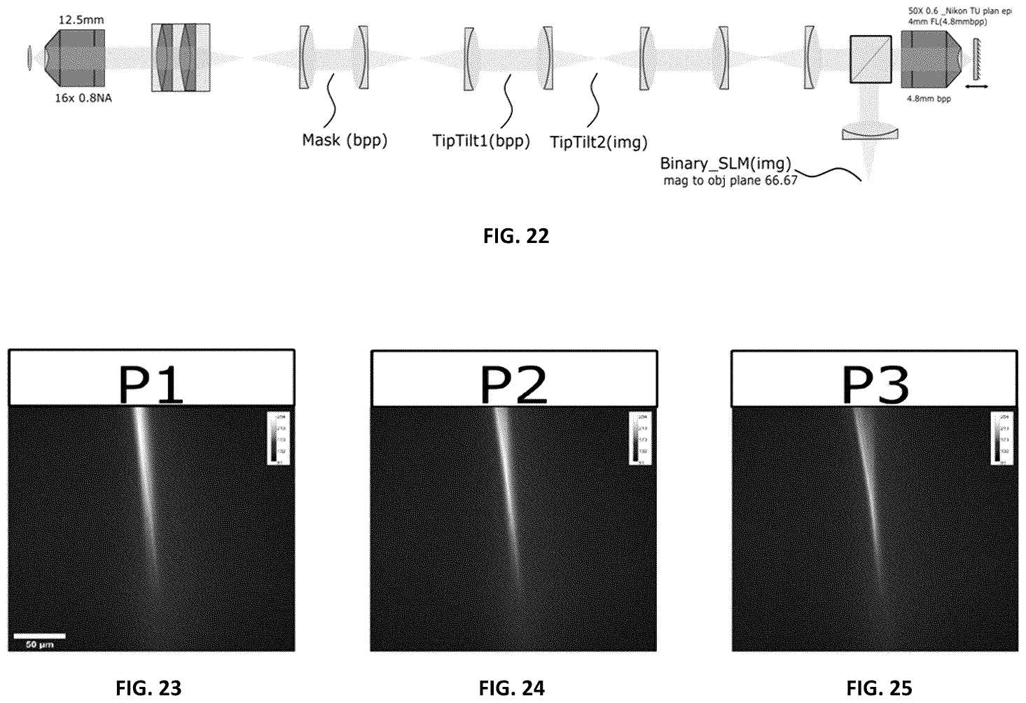

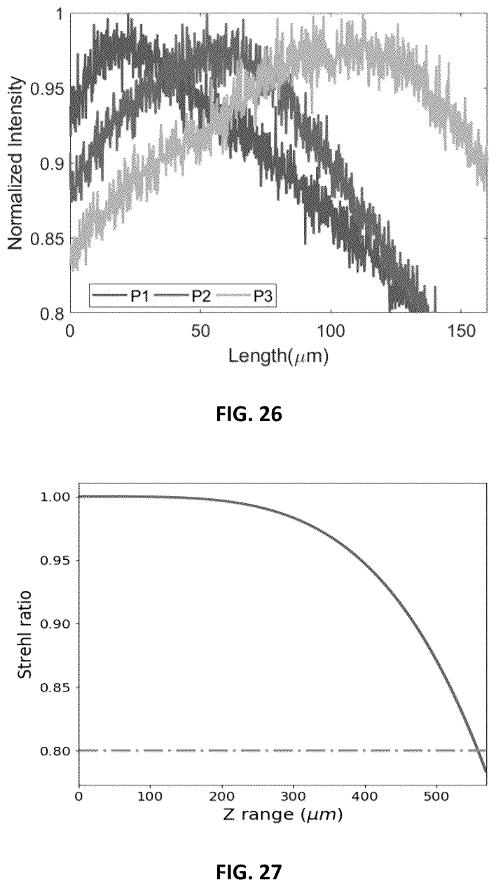

FIG. 21 illustrates shifting of a light beam waist using an optical design (FIG. 22) of a remote focusing system for a provided microscope. This system was tested with a fluorescent dye sample, showing a focus shift of the Gaussian beam waist across three positions with a 50-μm difference from P1 to P2, and from P2 to P3 (FIGS. 23-25). FIGS. 23-27 show that a Gaussian beam can be shifted at least 500 μm with a 0.45-NA illumination objective, resulting in a light sheet with a thickness of 542 nm.

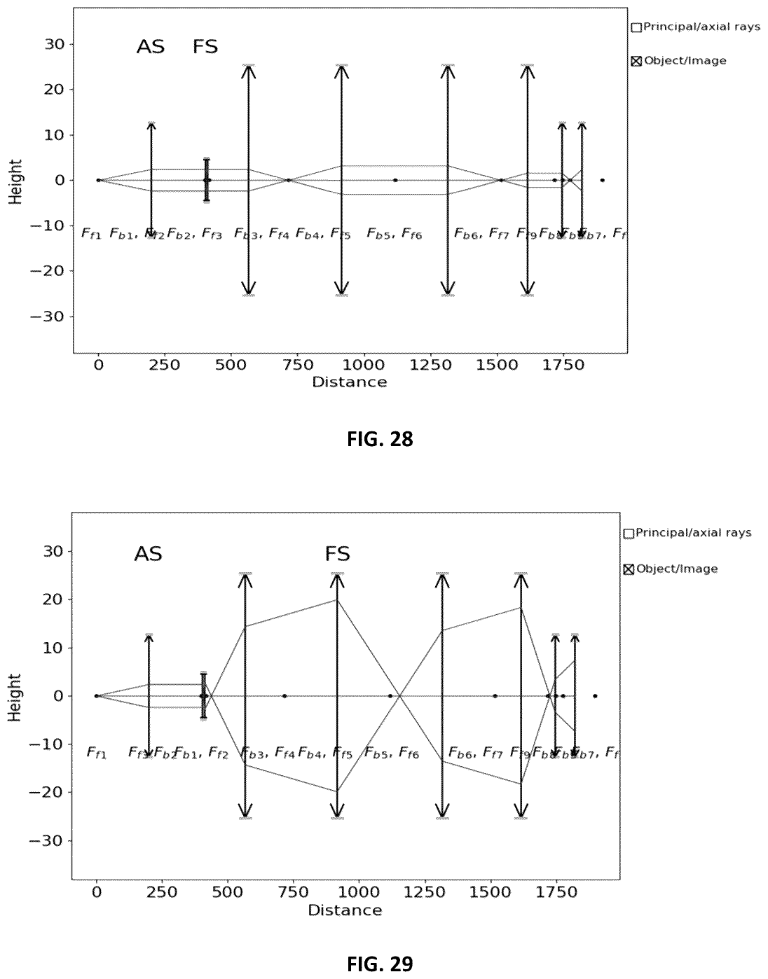

For provided microscopes in which structured light will be created, e.g., with a spatial light modulator, the remote focusing system still needs to be suitable for use with the largest pattern frequency of the structured illumination. This is because as the remote focusing is performed, the beam waist position also changes in relation to the focal plane of the objective lens. The diffracted light will either converge or diverge as it passes through the optical path. Therefore, confirmations are needed to make sure that the light will not be clipped by the lenses in between the objective lenses as the beam waist of the light sheet is shifted. Accordingly, a ray tracing simulation was performed to verify the design. Results of the simulation are shown in FIGS. 28-29.

### Example 8. Illumination Synchronization

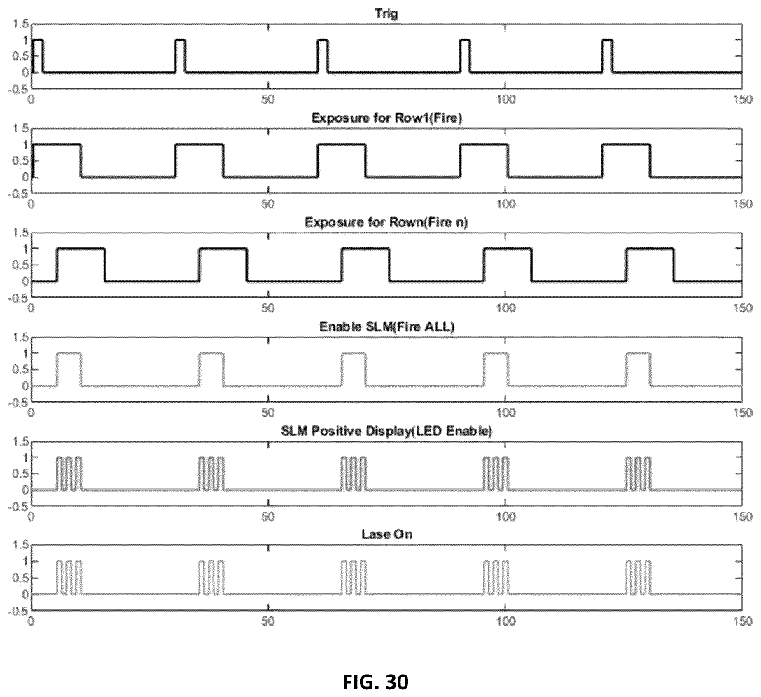

In some embodiments, the microscope includes a spatial light modulator (SLM) that is a binary microdisplay, which means that each pixel of the SLM can exist in only one of two states, on or off. The pixel is switched on and off by changing the polarity of the electrical field across it, and in this way the incident light is switched in polarization so it exits the other face of the beamsplitter cube. To prevent damage to the Liquid Crystal (LC), the net bias across the pixel must equal zero over time. This means that time between the pixel's on state and off state should be equal for each activation period. Therefore, the SLM is preferably synchronized with the pixel state using the laser and the camera exposure to capture one image. FIG. 30 illustrates how the illumination of the provided microscope is synchronized.

### Example 9. Beam Orientation for Multidirectional Light Sheet Illumination

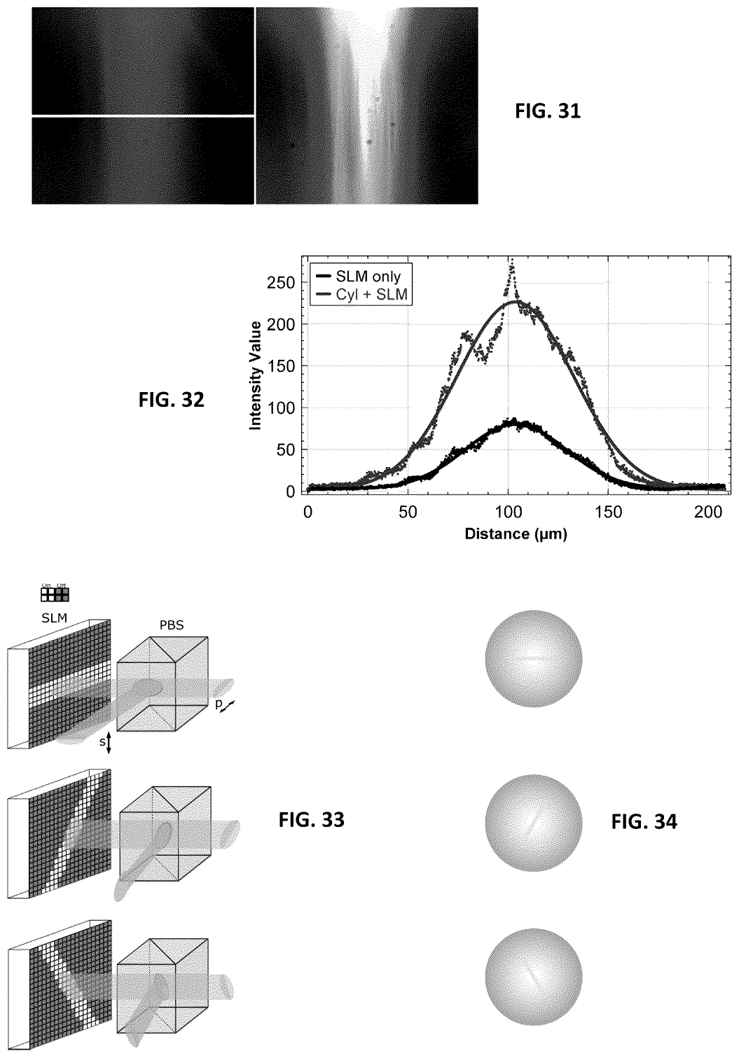

A rotational stage and achromatic cylindrical lens was used to rotate a focused line profile on the spatial light modulator of a provided microscope. FIGS. 31 and 32 show results of a comparison between the light throughput for a light sheet oriented using the spatial light modulator alone and a light sheet oriented with the cylindrical lens prior to structuring the beam with the spatial light modulator. A fluorescence dye sample (10 mM Alexa 488 mixed with 1% agarose gel in the ratio of 1:100) was imaged with the same laser intensity and camera exposure time (20 mw, 100 ms exposure time). As shown in FIG. 32, the measured intensity is increased by a factor of 3 through use of the cylindrical lens. FIGS. 33 and 34 show the multidirectional light sheet illumination working principle, where a laser beam with a line profile is oriented in 0, 120, and 240 degree. Then the laser beam is steered at the conjugated back pupil plane of the objective lens, so that the beam is reflected by hypotenuse of the micro prism that is coated with aluminum.

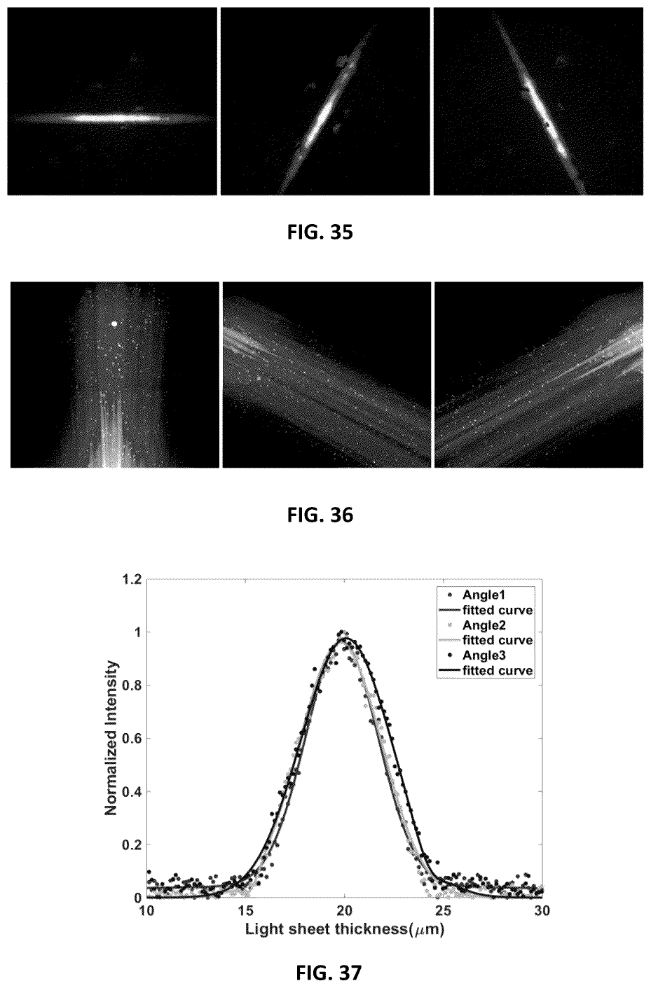

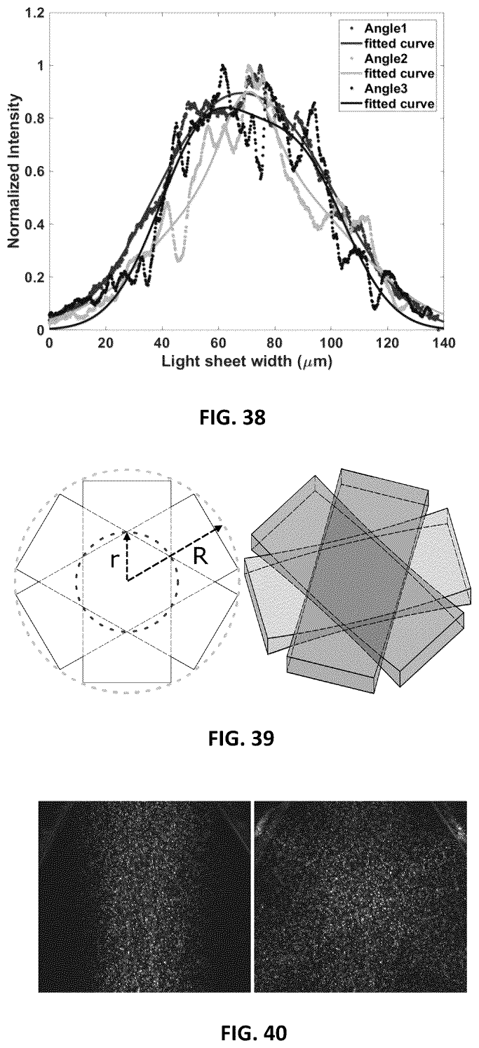

The cylindrical lens can create an 8.57×0.532 mm² line profile at the SLM, which is conjugate to the front image plane of the illumination objective lens. This translates to a sheet 4.65 μm in thickness (FWHM). This can be further adjusted by controlling the number of the on-state pixels of the SLM in the width direction of the light sheet. In addition to adjusting the thickness of the light sheet, different structured patterns can be displayed to create illumination patterns so that structured illumination can be implemented for all directions. In order to quantify the light sheet thickness, a fluorescent dye sample is used to measure the light sheet thickness as well as the width. Here, the light sheet has a thickness of 4.768+/−0.177 μm and a width of 63.93+/−4.76 μm in FWHM. This value is close to a designed parameter of the light sheet, which can have a 4.697-μm thickness and 75.65-μm width. The resulting light sheet profiles are shown in FIGS. 35-38 for multidirectional light sheet illumination using a fluorescent dye sample mixed with yellow-green fluorescent beads.

### Example 10. Imaging Area of the Multidirectional Light Sheet

In conventional light sheet microscopy, the imaging area is defined by the light sheet width as well as by the Rayleigh range in combination with the overall magnification of the sensor size. In some embodiments, the overall magnification of the provided microscope is 48×. This results in a 276.5-μm field of view (FOV) with a pixel size of 135 nm. The light sheet in this case is 75 μm in width and 278 μm in length. When multidirectional illumination is implemented, the penetration depth increases. FIGS. 39 and 40 show results from using the average of multiple images from different illumination directions to fuse into one final image.

### Example 11. Point Spread Function and 3D Imaging

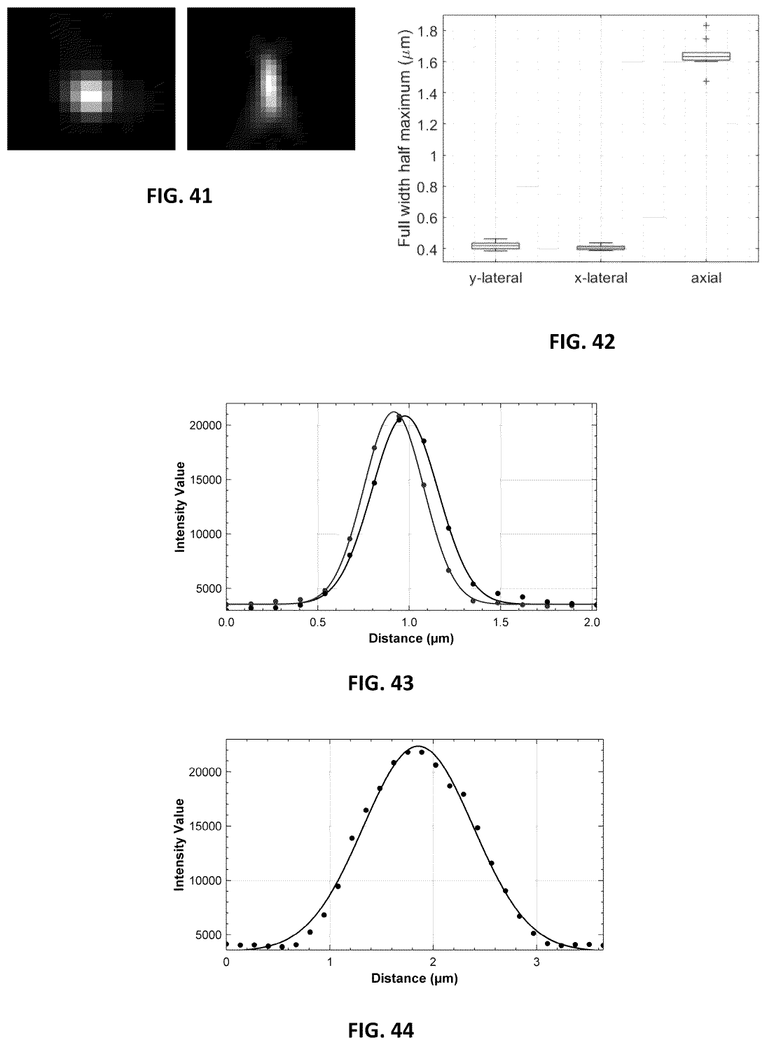

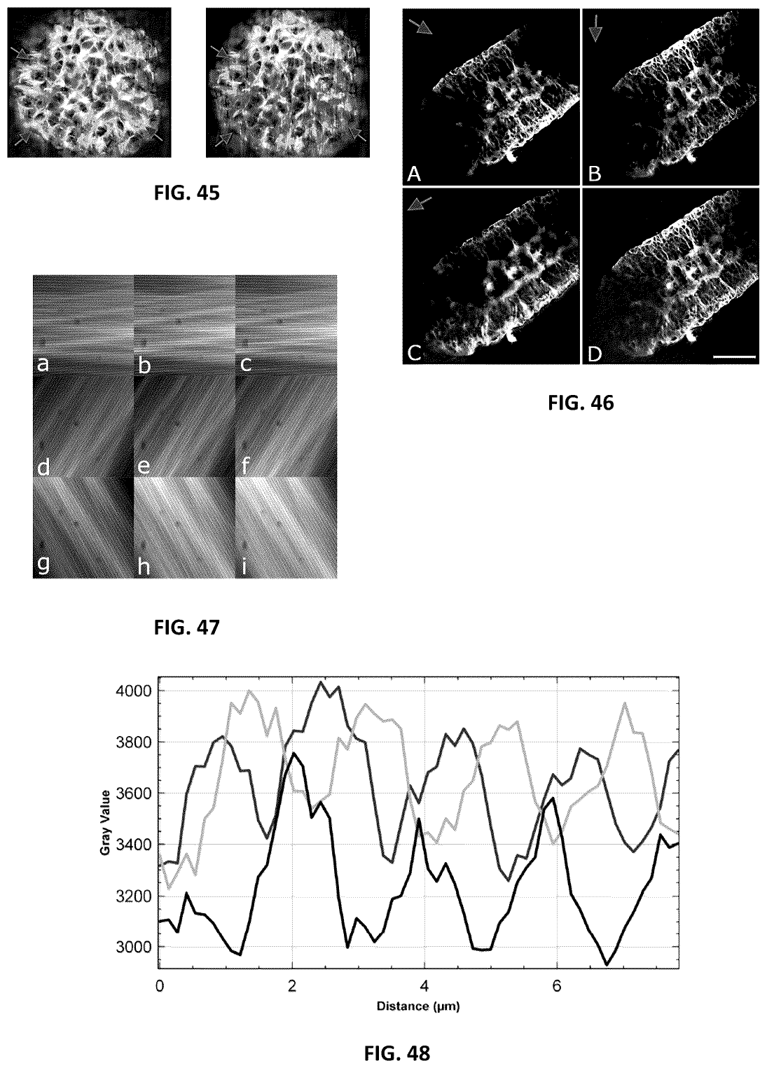

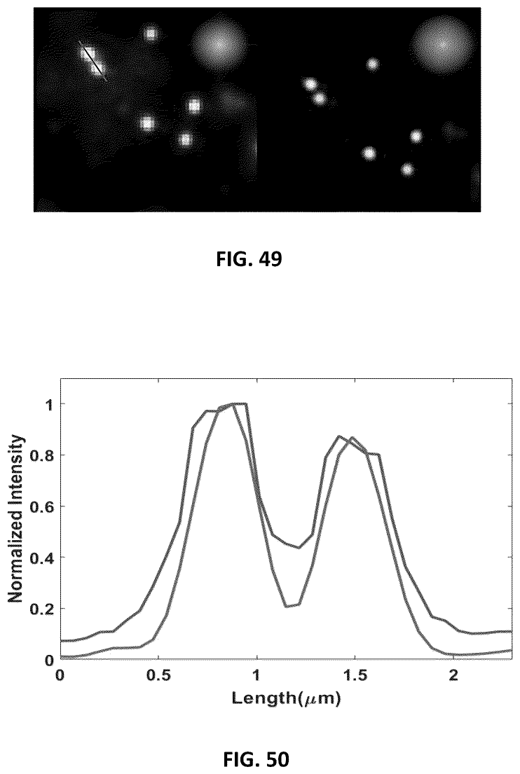

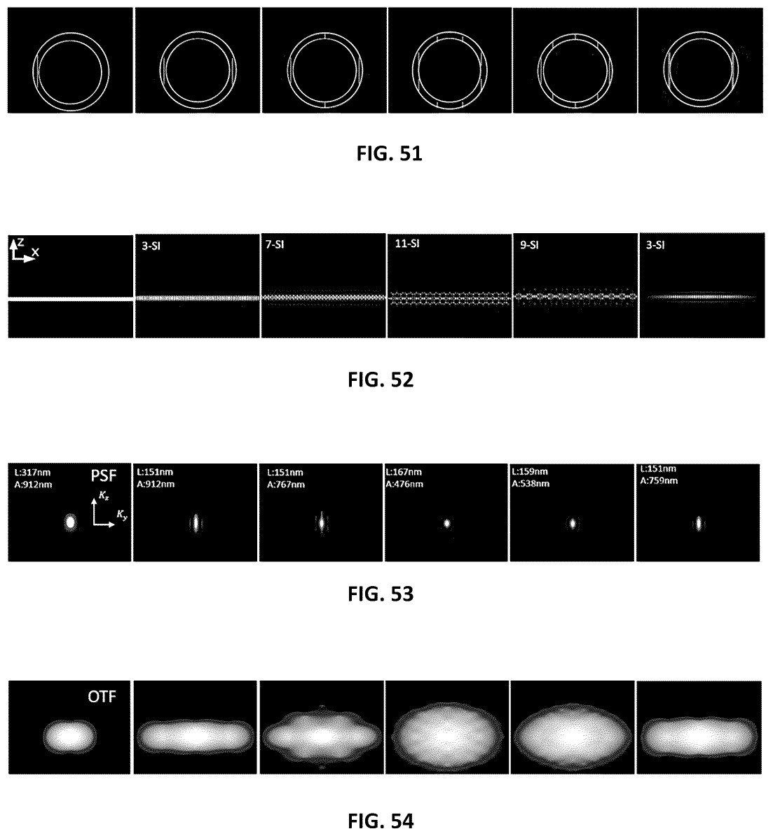

To quantify the performance of a provided microscope, 200-nm yellow-green fluorescent micro-spheres were imaged and the lateral and axial point spread functions were recorded (FIG. 41). Ten of the beads were selected at random locations. The average FWHM was 417+/−23 nm in the y lateral direction, 406+/−17 nm in the x lateral direction, and 1.64+/−0.09 μm in the axial direction. The graphs of FIGS. 43 and 44 show representative line profiles, and the box plot of FIG. 42 shows a random selection of 10 measurements across the 10-μm image stacks. Additionally, a cerebellum organoid was imaged after being fixed on day 7 with 4% PFA and stained for neuronal marker Tuj1 with Alexa 488 dye. FIG. 45 shows imaging results with a maximum projection over 20 μm, demonstrating improved imaging with multi-angle illumination relative to imaging using a unidirectional illumination light sheet.

### Example 12. Structured Illumination with Light Sheet Fluorescence Microscopy

Structured illumination was used to boost the isotropic resolution of the provided microscope system. A fluorescent dye phantom and a wavelength with a shorter wavelength were used to show that a sinusoidal pattern can be created from three directions 120 degrees apart from each other. FIG. 47 shows a 20-pixel pattern at the spatial light modulator with a wavelength of 1.22 μm. The line profile is shown in a set of three phases. Further, a fluorescent beads sample was imaged to demonstrate that the microscope is able to achieve a resolution boost of 1.2× in all lateral directions. Additionally, the line intensity profile was compared with single-direction light sheet fluorescence microscopy illumination as shown in FIG. 48. A FWHM measurement of 317+/−32 nm was achieved with 10 measurements of 200-nm beads, approaching a theoretical resolution of 268 nm after a 1.2× resolution boost.

A finer pixel pattern can be used to further improve the resolution a to 2× boost, however a 4-μm light sheet may require a mask with tight tolerance at the conjugated back pupil plane. The rotation stage for the cylindrical lens has an axial wobble of 0.103 degrees, translating to a shift of 500 μm at the spatial light modulator. This causes displacement of the diffraction order from its designed position, causing it to not pass through the mask as result. However, a light sheet with a shorter Rayleigh range may use a mask with larger openings and fewer rotation stages for the cylindrical lens.

The results demonstrate that a provided microscope is capable of imaging a thick biological specimen over, for example, a 277-μm field of view. The microscope can have, for example, a 1.2× resolution boost isotropically. The microscope system is synchronized using both electrical signals and software commands from the computer. Faster imaging speeds can be achieved by using only electrical signals for all the parts of the microscope.

Although the foregoing disclosure has been described in some detail by way of illustration and example for purpose of clarity of understanding, one of skill in the art will appreciate that certain changes and modifications within the spirit and scope of the disclosure may be practiced, e.g., within the scope of the appended claims. It should also be understood that aspects of the disclosure and portions of various recited embodiments and features can be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only and is not intended to limit the disclosure. In addition, each reference provided herein is incorporated by reference in its entirety for all purposes to the same extent as if each reference was individually incorporated by reference.

What is claimed is:

1. A microscope for imaging a sample within a sample volume, wherein the microscope comprises:
a laser configured to emit an illumination light;
a beam shaper configured to generate a light sheet from the illumination light;
an objective lens having an optical axis, wherein the objective lens is configured to transmit the light sheet to and transmit detection light exiting from the sample volume;
two or more reflectors each located in a different position in a sample plane that transects the sample volume orthogonal to the optical axis;
a beam steering mirror;
a steering motor configured to move the beam steering mirror to each of two or more positions, wherein at each of the two or more positions the beam steering mirror is configured to steer the light sheet through the objective lens to a different selected reflector of the two or more reflectors, the light sheet reflected from the selected reflector through the sample volume; and
an imager configured to image the detection light transmitted by the objective lens.

2. The microscope of claim 1, wherein the distances from each of the two or more reflectors to the optical axis are substantially equal.

3. The microscope of claim 1, wherein the angular separations of the two or more reflectors about the optical axis are substantially equal.

4. The microscope of claim 1, wherein the microscope further comprises:
a remote focuser configured to position a beam waist of the light sheet substantially at an intersection of the sample plane and the optical axis.

5. The microscope of claim 1, wherein the beam shaper comprises a cylindrical lens.

6. The microscope of claim 5, wherein the beam shaper comprises a rotational motor configured to rotate the cylindrical lens, thereby rotating the light sheet.

7. The microscope of claim 1, wherein the beam steering mirror is a first beam steering mirror, the microscope further comprising:
a second beam steering mirror configured to move such that the moved second beam steering mirror steers the light sheet such that the selected reflector directs the light sheet through the sample volume and substantially in the sample plane.

8. The microscope of claim 1, wherein the microscope further comprises:
a beam structurer configured to add structure the light sheet.

9. The microscope of claim 8, wherein the beam structurer comprises a spatial light modulator.

10. The microscope of claim 9, wherein the beam structurer comprises a polarized beam splitter.

11. The microscope of claim 1, wherein each of the two or more reflectors is attached to a sample stage of the microscope.

12. The microscope of claim 1, wherein each of the two or more reflectors is attached to the objective lens.

13. The microscope of claim 1, wherein each of the two or more reflectors independently comprises a prism having a reflective surface.

14. A method for imaging a sample within a sample volume with a microscope, wherein the method comprises:
emitting, using a laser, an illumination light;
generating, using a beam shaper, a light sheet from the illumination light;
transmitting the light sheet through an objective lens to a first reflector of two or more reflectors, wherein the objective lens has an optical axis, and wherein each of the two or more reflectors is located in a different position in a sample plane that transects the sample volume orthogonal to the optical axis;
directing, using the first reflector, the light sheet through the sample volume and substantially in the sample plane;
detecting, using an imager, a first detection light, wherein the first detection light exits the sample volume as the light sheet is directed with the first reflector, and wherein the first detection light is transmitted through the objective lens to the imager;
moving a beam steering mirror such that the moved beam steering mirror steers the light sheet such that upon exiting the objective lens the light sheet is directed to a second reflector of the two or more reflectors; and
detecting, using the imager, a second detection light, wherein the second detection light exits the sample volume as the light sheet is directed with the second reflector, and wherein the second detection light is transmitted through the objective lens to the imager.

15. The method of claim 14, wherein the method further comprises:
positioning, using a remote focuser, a beam waist of the light sheet substantially at an intersection of the sample plane and the optical axis.

16. The method of claim 14, wherein the method further comprises:
rotating a cylindrical lens of the microscope, thereby rotating the light sheet.

17. The method of claim 14, wherein the beam steering mirror is a first beam steering mirror, the method further comprising:
moving a second beam steering mirror such that the moved second beam steering mirror steers the light sheet such that the second reflector directs the light sheet through the sample volume and substantially in the sample plane.

18. The method of claim 14, wherein the method further comprises:
structuring the light sheet using a beam structurer.

19. A machine-readable non-transitory medium embodying information indicative of instructions for causing a computer processor to perform operations for controlling a microscope to perform the method of claim 14.

20. A computer system for displaying images, the computer system comprising at least one processor, and a memory operatively coupled with the at least one processor, the at least one processor executing instructions from the memory comprising program code for controlling a microscope to perform the method of claim 14.
